(19) United States
(12) Patent Application Publication
(10) Pub. No.: US 2025/0301549 A1
(43) Pub. Date: Sep. 25, 2025

(54) TECHNIQUES FOR ILLUMINATING A PHYSICAL SPACE

(71) Applicant: Apple Inc., Cupertino, CA (US)

(72) Inventors: Felipe BACIM DE ARAUJO E SILVA, San Jose, CA (US); Jean-Pierre M. MOUILLESEAUX, San Carlos, CA (US); Karlin Y. BARK, San Carlos, CA (US)

(21) Appl. No.: 19/056,198

(22) Filed: Feb. 18, 2025

Related U.S. Application Data
(60) Provisional application No. 63/567,821, filed on Mar. 20, 2024.

(51) Int. Cl. H05B 47/11; H05B 47/175

(52) U.S. Cl. CPC H05B 47/11; H05B 47/196

(57) ABSTRACT

The present disclosure generally relates to simulating light in a physical space, such as simulating light passing through a physical opening, for simulating different amounts of light passing through a physical opening, and/or for adjusting one or more lighting conditions.

### CROSS-REFERENCE TO RELATED APPLICATIONS

The present application claims priority to U.S. Provisional Patent Application Ser. No. 63/567,821, entitled “TECHNIQUES FOR ILLUMINATING A PHYSICAL SPACE,” filed Mar. 20, 2024, which is hereby incorporated by reference in its entirety for all purposes.

### FIELD

The present disclosure relates generally to computer user interfaces, and more specifically to techniques for illuminating a physical space.

### BACKGROUND

Lights illuminate physical spaces. Such lights can be controlled by a user to change the manner in which one or more physical spaces are illuminated.

### SUMMARY

Some techniques for illuminating a physical space using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for illuminating a physical space. Such methods and interfaces optionally complement or replace other methods for illuminating a physical space. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a light source and an input device is described. In some embodiments, the method comprises: detecting, via the input device, a request to illuminate a physical space; and in response to detecting the request to illuminate the physical space: in accordance with a determination that a first portion of the physical space is set as a passthrough of light, providing, via the light source, illumination in a first manner; and in accordance with a determination that the first portion of the physical space is not set as a passthrough of light, forgoing providing illumination in the first manner.

In some embodiments, a non-transitory computer-readable storage medium storing one or more programs configured to be executed by one or more processors of a computer system that is in communication with a light source and an input device is described. In some embodiments, the one or more programs includes instructions for: detecting, via the input device, a request to illuminate a physical space; and in response to detecting the request to illuminate the physical space: in accordance with a determination that a first portion of the physical space is set as a passthrough of light, providing, via the light source, illumination in a first manner; and in accordance with a determination that the first portion of the physical space is not set as a passthrough of light, forgoing providing illumination in the first manner.

In some embodiments, a transitory computer-readable storage medium storing one or more programs configured to be executed by one or more processors of a computer system that is in communication with a light source and an input device is described. In some embodiments, the one or more programs includes instructions for: detecting, via the input device, a request to illuminate a physical space; and in response to detecting the request to illuminate the physical space: in accordance with a determination that a first portion of the physical space is set as a passthrough of light, providing, via the light source, illumination in a first manner; and in accordance with a determination that the first portion of the physical space is not set as a passthrough of light, forgoing providing illumination in the first manner.

In some embodiments, a computer system configured to communicate with a light source and an input device is described. In some embodiments, the computer system comprises one or more processors and memory storing one or more programs configured to be executed by the one or more processors. In some embodiments, the one or more programs includes instructions for: detecting, via the input device, a request to illuminate a physical space; and in response to detecting the request to illuminate the physical space: in accordance with a determination that a first portion of the physical space is set as a passthrough of light, providing, via the light source, illumination in a first manner; and in accordance with a determination that the first portion of the physical space is not set as a passthrough of light, forgoing providing illumination in the first manner.

In some embodiments, a computer system configured to communicate with a light source and an input device is described. In some embodiments, the computer system comprises means for performing each of the following steps: detecting, via the input device, a request to illuminate a physical space; and in response to detecting the request to illuminate the physical space: in accordance with a determination that a first portion of the physical space is set as a passthrough of light, providing, via the light source, illumination in a first manner; and in accordance with a determination that the first portion of the physical space is not set as a passthrough of light, forgoing providing illumination in the first manner.

In some embodiments, a computer program product is described. In some embodiments, the computer program product comprises one or more programs configured to be executed by one or more processors of a computer system that is in communication with a light source and an input device. In some embodiments, the one or more programs include instructions for: detecting, via the input device, a request to illuminate a physical space; and in response to detecting the request to illuminate the physical space: in accordance with a determination that a first portion of the physical space is set as a passthrough of light, providing, via the light source, illumination in a first manner; and in accordance with a determination that the first portion of the physical space is not set as a passthrough of light, forgoing providing illumination in the first manner.

In some embodiments, a method that is performed at a computer system that is in communication with a light source and an input device is described. In some embodiments, the method comprises: detecting, via the input device, a request to change a size of a physical window in a physical space; and in response to detecting the request to change the size of the physical window in the physical space: in accordance with a determination that the request corresponds to a first size, providing, via the light source, illumination in a first manner; and in accordance with a determination that the request corresponds to a second size different from the first size, providing, via the light source, illumination in a second manner different from the first manner.

In some embodiments, a non-transitory computer-readable storage medium storing one or more programs configured to be executed by one or more processors of a computer system that is in communication with a light source and an input device is described. In some embodiments, the one or more programs includes instructions for: detecting, via the input device, a request to change a size of a physical window in a physical space; and in response to detecting the request to change the size of the physical window in the physical space: in accordance with a determination that the request corresponds to a first size, providing, via the light source, illumination in a first manner; and in accordance with a determination that the request corresponds to a second size different from the first size, providing, via the light source, illumination in a second manner different from the first manner.

In some embodiments, a transitory computer-readable storage medium storing one or more programs configured to be executed by one or more processors of a computer system that is in communication with a light source and an input device is described. In some embodiments, the one or more programs includes instructions for: detecting, via the input device, a request to change a size of a physical window in a physical space; and in response to detecting the request to change the size of the physical window in the physical space: in accordance with a determination that the request corresponds to a first size, providing, via the light source, illumination in a first manner; and in accordance with a determination that the request corresponds to a second size different from the first size, providing, via the light source, illumination in a second manner different from the first manner.

In some embodiments, a computer system configured to communicate with a light source and an input device is described. In some embodiments, the computer system comprises one or more processors and memory storing one or more programs configured to be executed by the one or more processors. In some embodiments, the one or more programs includes instructions for: detecting, via the input device, a request to change a size of a physical window in a physical space; and in response to detecting the request to change the size of the physical window in the physical space: in accordance with a determination that the request corresponds to a first size, providing, via the light source, illumination in a first manner; and in accordance with a determination that the request corresponds to a second size different from the first size, providing, via the light source, illumination in a second manner different from the first manner.

In some embodiments, a computer system configured to communicate with a light source and an input device is described. In some embodiments, the computer system comprises means for performing each of the following steps: detecting, via the input device, a request to change a size of a physical window in a physical space; and in response to detecting the request to change the size of the physical window in the physical space: in accordance with a determination that the request corresponds to a first size, providing, via the light source, illumination in a first manner; and in accordance with a determination that the request corresponds to a second size different from the first size, providing, via the light source, illumination in a second manner different from the first manner.

In some embodiments, a computer program product is described. In some embodiments, the computer program product comprises one or more programs configured to be executed by one or more processors of a computer system that is in communication with a light source and an input device. In some embodiments, the one or more programs include instructions for: detecting, via the input device, a request to change a size of a physical window in a physical space; and in response to detecting the request to change the size of the physical window in the physical space: in accordance with a determination that the request corresponds to a first size, providing, via the light source, illumination in a first manner; and in accordance with a determination that the request corresponds to a second size different from the first size, providing, via the light source, illumination in a second manner different from the first manner.

In some embodiments, a method that is performed at a computer system that is in communication with an external light source and an input device is described. In some embodiments, the method comprises: detecting, via the input device, that a physical environment includes a respective color of light; and in response to detecting that the physical environment includes the respective color of light: in accordance with a determination that the respective color is a first color, providing, via the external light source, illumination in a first manner; and in accordance with a determination that the respective color is a second color different from the first color, providing, via the external light source, illumination in a second manner different from the first manner.

In some embodiments, a non-transitory computer-readable storage medium storing one or more programs configured to be executed by one or more processors of a computer system that is in communication with an external light source and an input device is described. In some embodiments, the one or more programs includes instructions for: detecting, via the input device, that a physical environment includes a respective color of light; and in response to detecting that the physical environment includes the respective color of light: in accordance with a determination that the respective color is a first color, providing, via the external light source, illumination in a first manner; and in accordance with a determination that the respective color is a second color different from the first color, providing, via the external light source, illumination in a second manner different from the first manner.

In some embodiments, a transitory computer-readable storage medium storing one or more programs configured to be executed by one or more processors of a computer system that is in communication with an external light source and an input device is described. In some embodiments, the one or more programs includes instructions for: detecting, via the input device, that a physical environment includes a respective color of light; and in response to detecting that the physical environment includes the respective color of light: in accordance with a determination that the respective color is a first color, providing, via the external light source, illumination in a first manner; and in accordance with a determination that the respective color is a second color different from the first color, providing, via the external light source, illumination in a second manner different from the first manner.

In some embodiments, a computer system configured to communicate with an external light source and an input device is described. In some embodiments, the computer system comprises one or more processors and memory storing one or more programs configured to be executed by the one or more processors. In some embodiments, the one or more programs includes instructions for: detecting, via the input device, that a physical environment includes a respective color of light; and in response to detecting that the physical environment includes the respective color of light: in accordance with a determination that the respective color is a first color, providing, via the external light source, illumination in a first manner; and in accordance with a determination that the respective color is a second color different from the first color, providing, via the external light source, illumination in a second manner different from the first manner.

In some embodiments, a computer system configured to communicate with an external light source and an input device is described. In some embodiments, the computer system comprises means for performing each of the following steps: detecting, via the input device, that a physical environment includes a respective color of light; and in response to detecting that the physical environment includes the respective color of light: in accordance with a determination that the respective color is a first color, providing, via the external light source, illumination in a first manner; and in accordance with a determination that the respective color is a second color different from the first color, providing, via the external light source, illumination in a second manner different from the first manner.

In some embodiments, a computer program product is described. In some embodiments, the computer program product comprises one or more programs configured to be executed by one or more processors of a computer system that is in communication with an external light source and an input device. In some embodiments, the one or more programs include instructions for: detecting, via the input device, that a physical environment includes a respective color of light; and in response to detecting that the physical environment includes the respective color of light: in accordance with a determination that the respective color is a first color, providing, via the external light source, illumination in a first manner; and in accordance with a determination that the respective color is a second color different from the first color, providing, via the external light source, illumination in a second manner different from the first manner.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for illuminating a physical space, thereby increasing the effectiveness, efficiency, and user satisfaction with such devices. Such methods and interfaces may complement or replace other methods for illuminating a physical space.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 6A-6B illustrate exemplary environments for simulating light passing through a physical opening.

FIG. 7 is a flow diagram illustrating a method for simulating light passing through a physical opening.

FIG. 8A-8B illustrate exemplary environments for simulating different amounts of light passing through a physical opening.

FIG. 9 is a flow diagram illustrating a method for simulating different amounts of light passing through a physical opening.

FIG. 10A-10B illustrate exemplary environments for adjusting one or more lighting conditions.

FIG. 11 is a flow diagram illustrating a method for adjusting one or more lighting conditions.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for illuminating a physical space. For example, a light passing through a window can be simulated within a physical space using one or more light sources in the physical space. Such techniques can reduce the cognitive burden on a user who desires to illuminate a physical space, thereby enhancing productivity. Further, such techniques can reduce processor and battery power otherwise wasted on redundant user inputs.

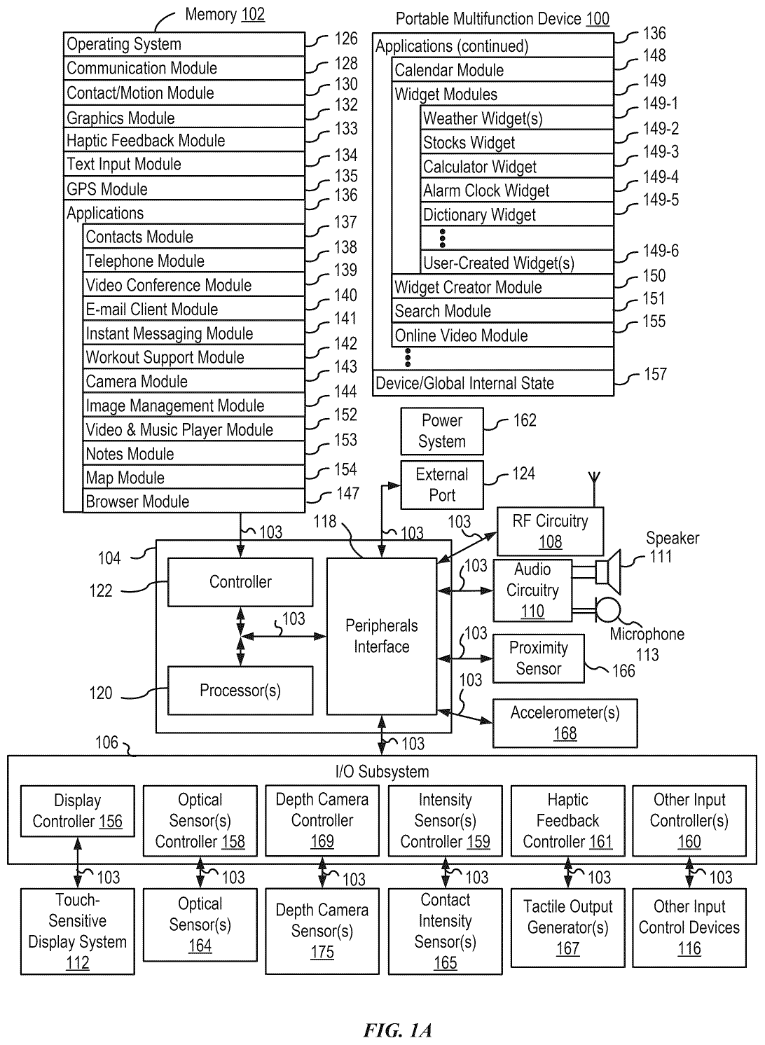

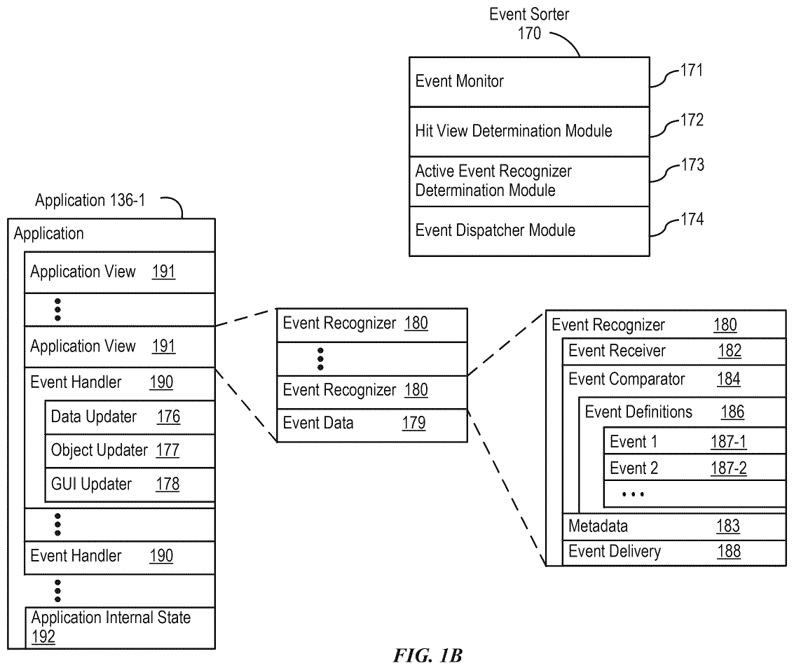

Below, FIGS. 1A-1B, 2, 3, 4A-4B, and 5A-5B provide a description of exemplary devices for performing the techniques for illuminating a physical space.

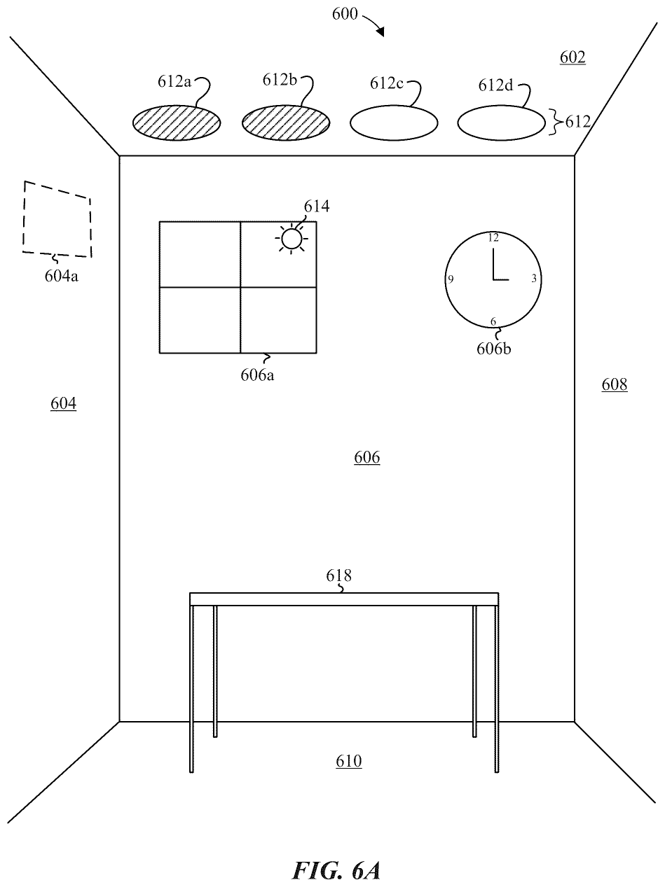

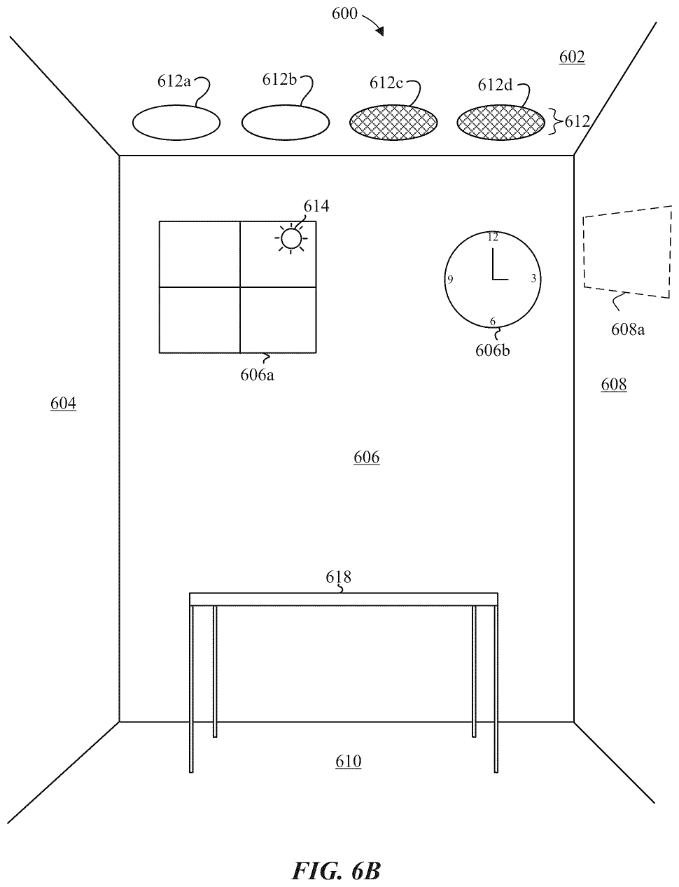

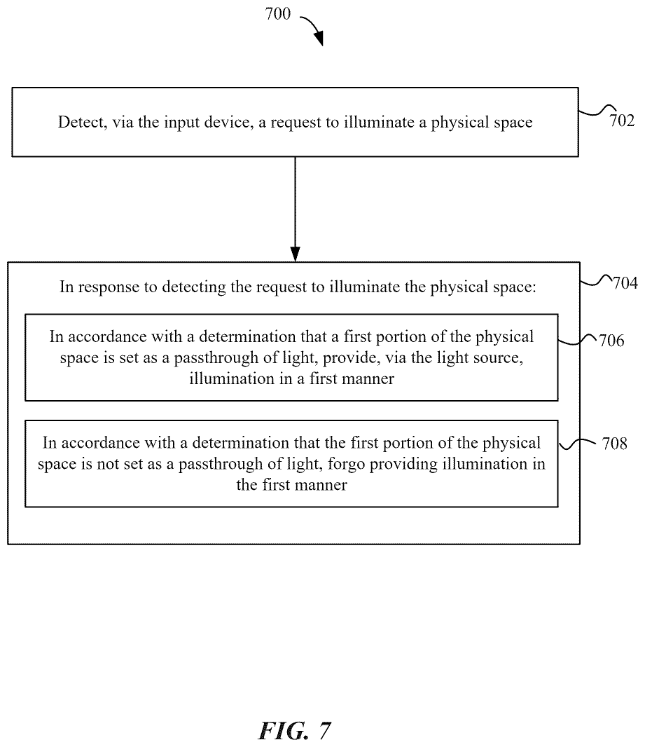

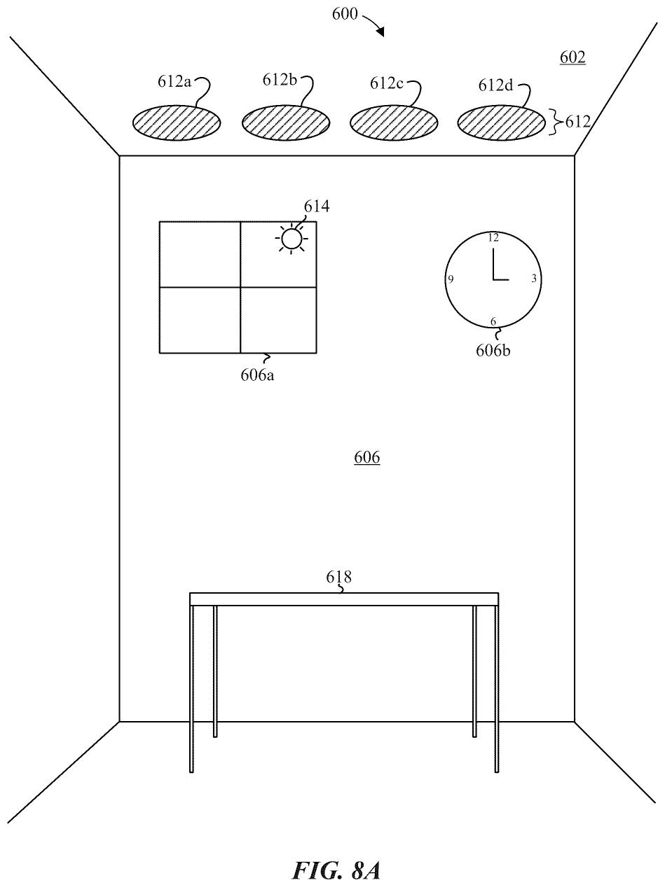

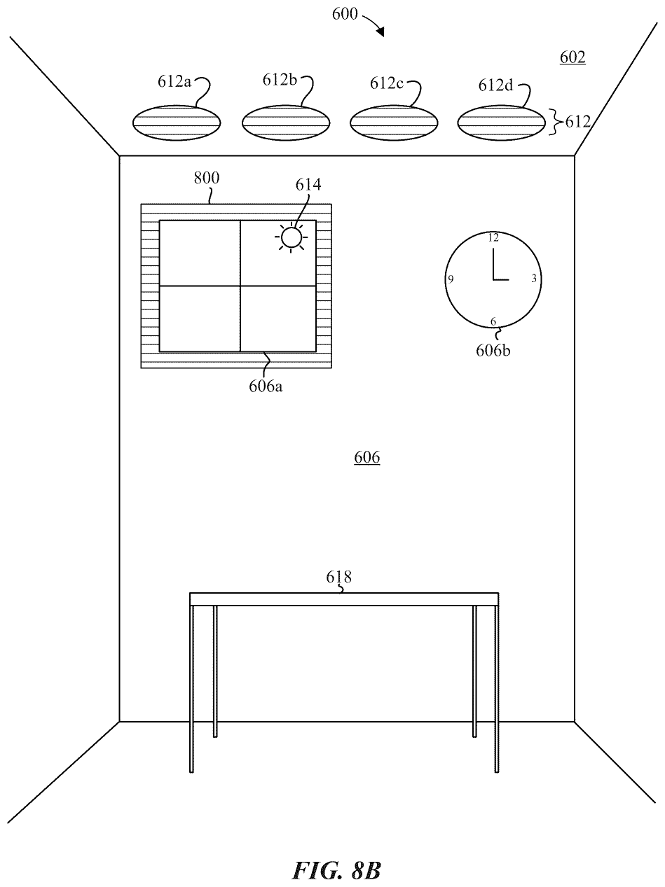

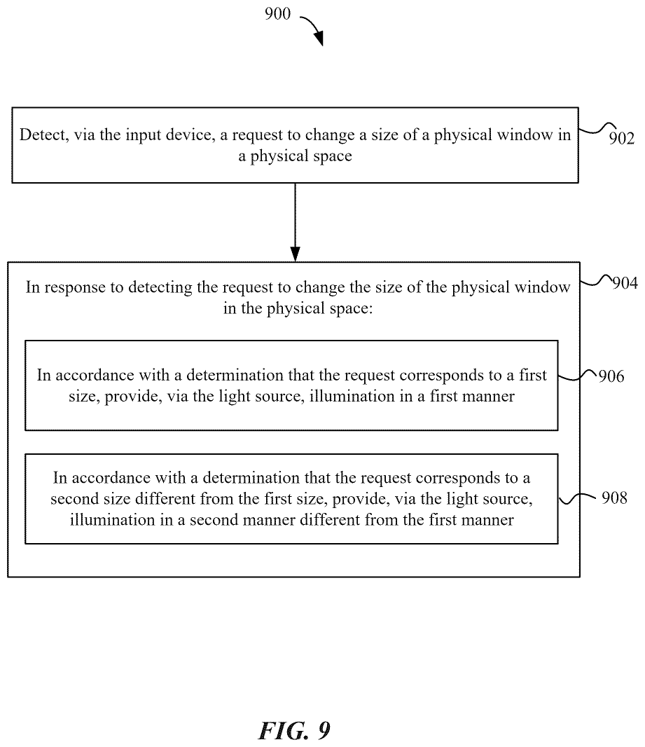

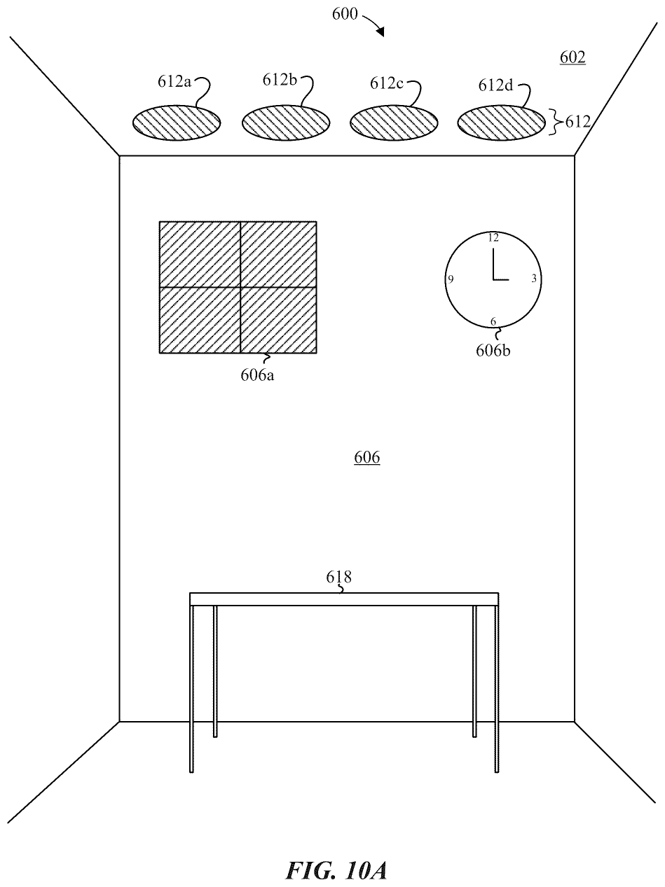

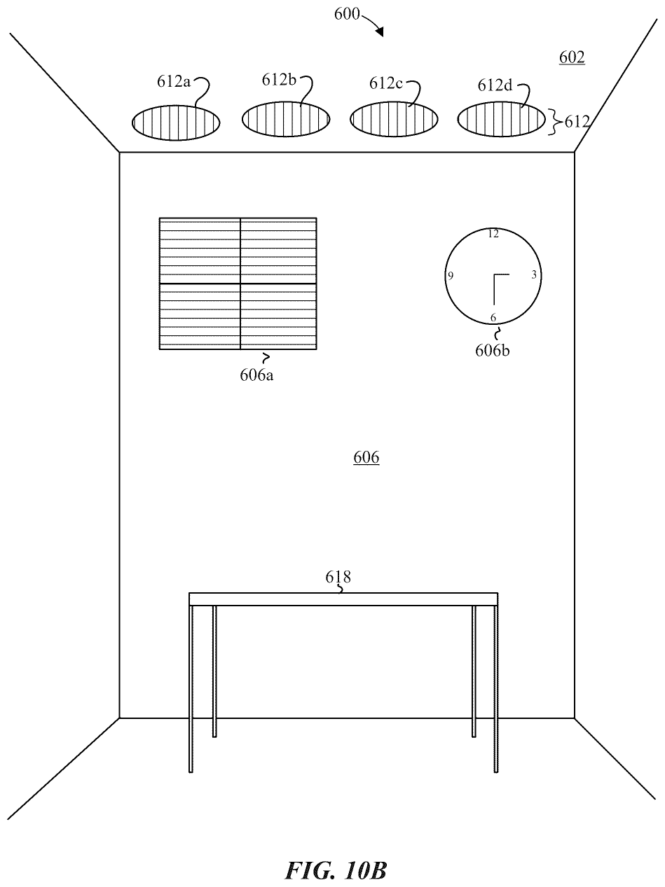

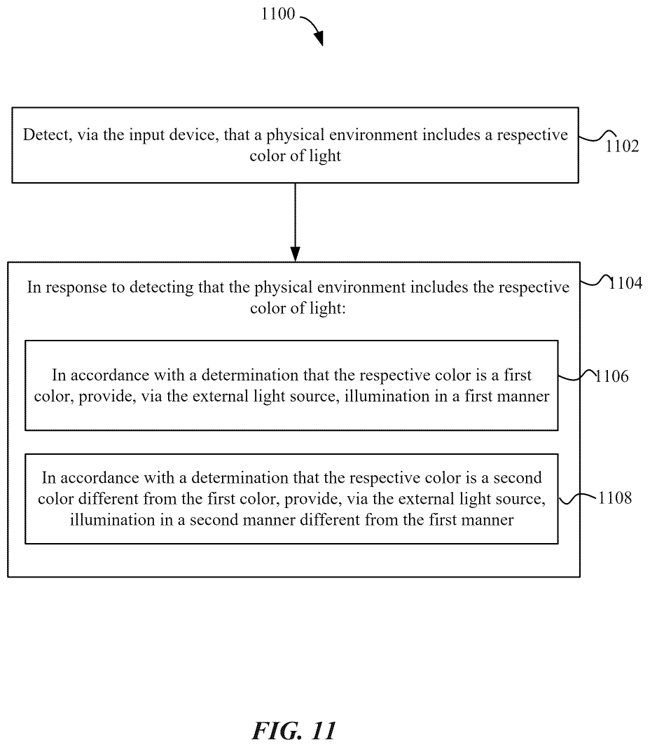

FIGS. 6A-6B illustrate exemplary environments for simulating light passing through a physical opening. FIG. 7 is a flow diagram illustrating methods for simulating light passing through a physical opening. The environments in FIGS. 6A-6B are used to illustrate the processes described below, including the processes in FIG. 7. FIGS. 8A-8B illustrate exemplary environments for simulating different amounts of light passing through a physical opening. FIG. 9 is a flow diagram illustrating methods for simulating different amounts of light passing through a physical opening. The environments in FIGS. 8A-8B are used to illustrate the processes described below, including the processes in FIG. 9. FIGS. 10A-10B illustrate exemplary environments for adjusting one or more lighting conditions. FIG. 11 is a flow diagram illustrating methods for adjusting one or more lighting conditions. The user interfaces in FIGS. 10A-10B are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

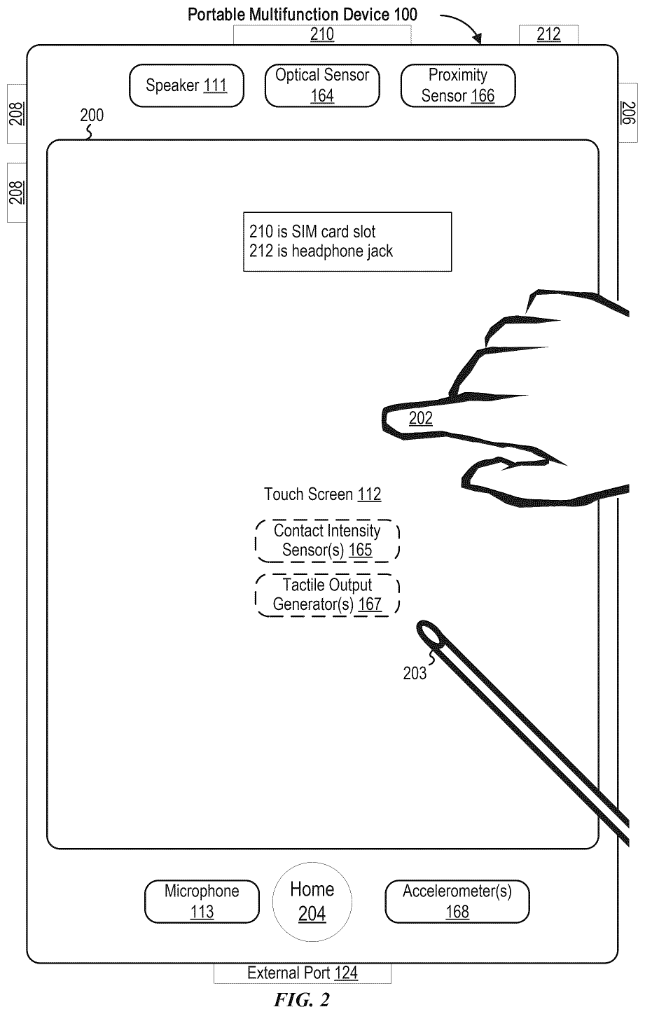

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three-dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods and Apparatuses for Operating a Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

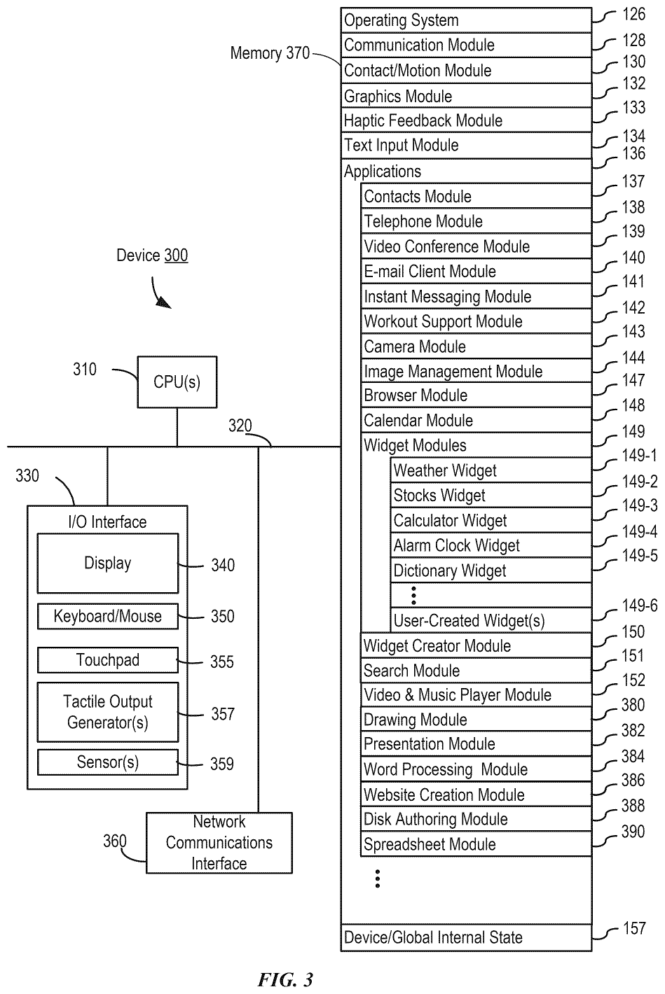

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds is determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the sets of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137 or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

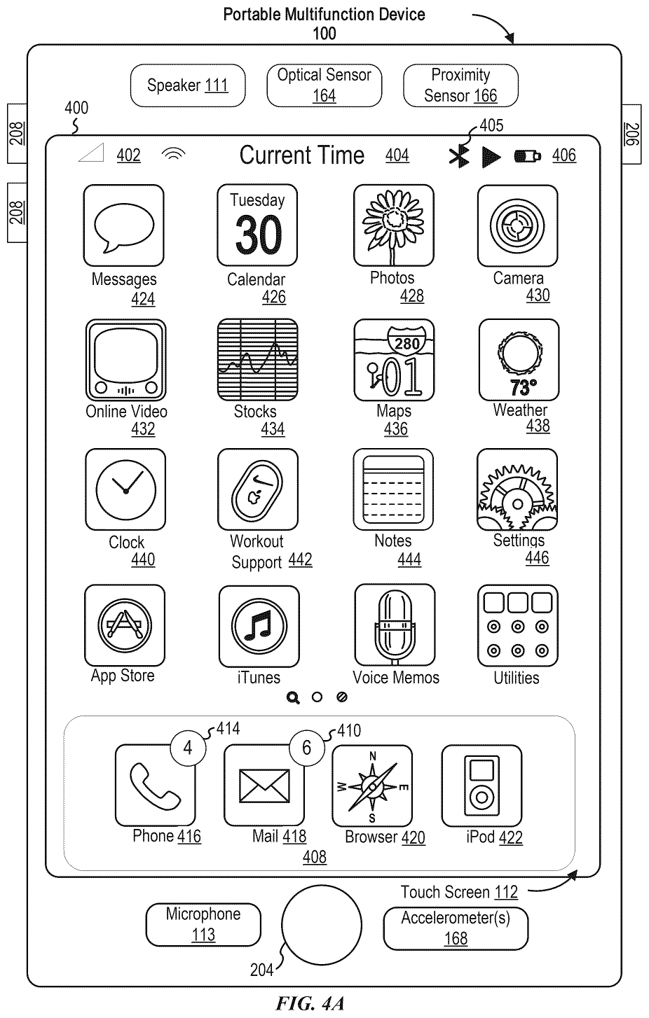

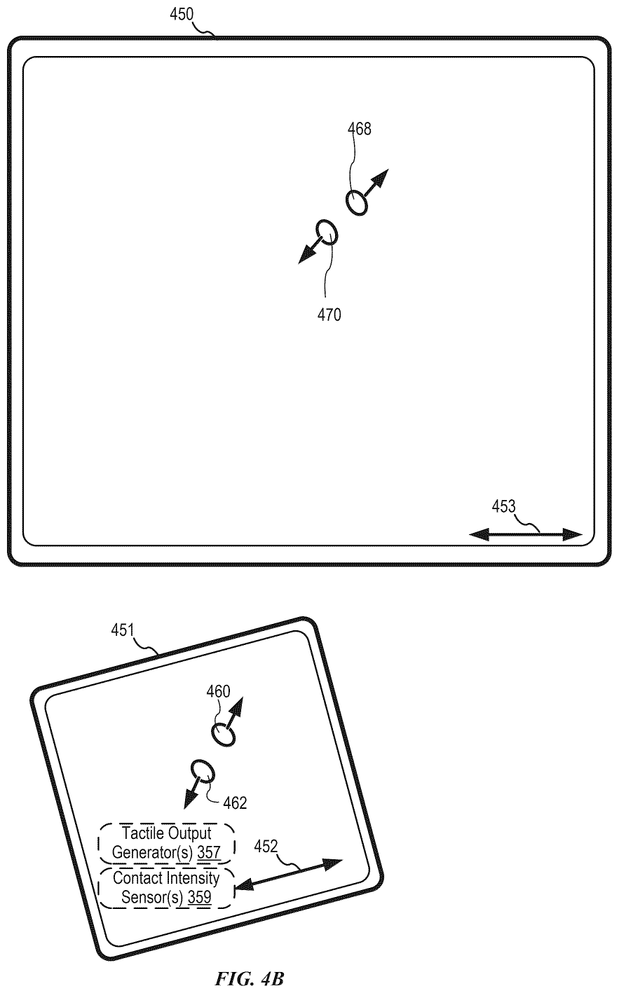

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

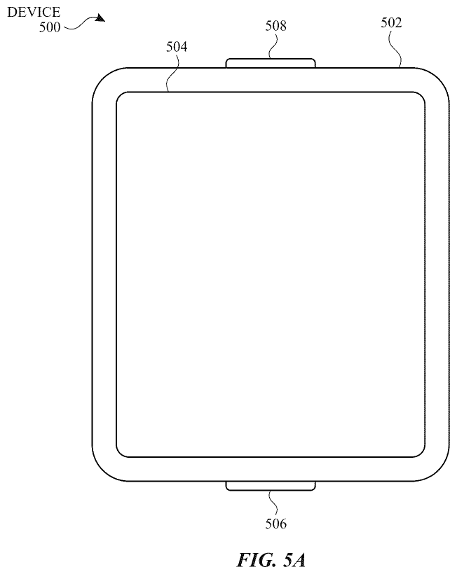

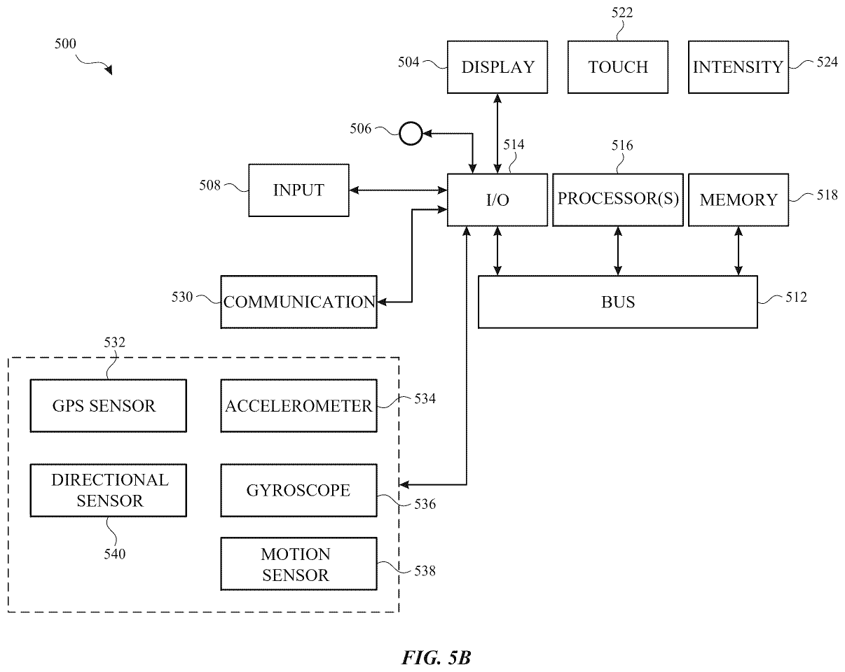

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some embodiments.

Input mechanism 508 is, optionally, a microphone, in some embodiments. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and 1100 (FIGS. 7, 9, and 11). A computer-readable storage medium can be any medium that can tangibly contain or store computer-executable instructions for use by or in connection with the instruction execution system, apparatus, or device. In some embodiments the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6B illustrate exemplary environments for simulating light passing through a physical opening in accordance with some embodiments. The user interfaces in these figures are used to illustrate the processes described below, including the processes in FIG. 7.

FIG. 6A illustrates physical space 600, which is a room in a house. Physical space 600 includes several physical features, such as ceiling 602, left wall 604 (e.g., the wall to the left in FIG. 6A), middle wall 606 (e.g., the center wall in FIG. 6A), right wall 608 (e.g., the wall to the right in FIG. 6A), and floor 610. In some embodiments, physical space 600 is a different physical space, such as a physical space for an office, building, vehicle, and/or barn, and/or includes one or more different or same physical features as those represented in FIG. 6A.

As illustrated in FIG. 6A, window 606a and clock 606b are located on middle wall 606. Window 606a is a window where light passes through from the physical environment that is exterior to physical space 600 into physical space 600. At FIG. 6A, sun 614 is a part of the physical environment that is exterior to physical space 600, where the light from sun 614 is currently passing through window 606a and impacts the physical environment interior to physical space 600. Also, as illustrated in FIG. 6A, desk 618 is positioned on top of floor 610. Desk 618 represents an object in the physical environment that is interior to physical space 600. In some embodiments, desk 618 can cause one or more shadows in the physical environment interior to physical space 600 to appear when physical space 600 is being illuminated by a light source and/or the physical environment that is exterior to physical space 600.

As illustrated in FIGS. 6A, ceiling 602 includes light sources 612, which are physically connected to ceiling 602. Light sources 612 includes light sources 612a-612d, which are used to illuminate physical space 600. In some embodiments, light sources 612 are in communication with one or more other devices (e.g., computer systems and/or processing devices). For example, light sources 612 can communicate with one or more sensor devices directly and/or indirectly via one or more computing devices that are in communication with the one or more sensor devices. In some embodiments, the one or more sensor devices detect changes and/or the level of one or more properties of a physical space, such as an amount of ambient light and/or movement in the environment. As another example, light sources 612 can communicate with one or more processing devices that process sensor data, determine illumination levels, and/or process inputs that assist and/or instruct light sources 612 to output illumination as described in the examples described herein. For ease of explanation, various operations (e.g., outputting illumination, detecting input, and/or determining properties) are described below as being performed by light sources 612. However, it should be recognized that one or more of the operations described below is performed by a device different from light sources 612, such as one or more personal computing devices (e.g., a phone, a tablet, a laptop, a desktop, a head-mounted display (HMD) device, and/or a wearable device) and/or communal devices (e.g., a smart speaker, a television, a router, and/or a hub). In some embodiments, the one or more computing devices and/or communal devices include one or more features and/or components of devices 100, 300, and/or 500 as described above. Unless otherwise noted explicitly, this description should not be construed as limiting the scope of such operations to be performed by a single device (e.g., light sources 612) or a particular combination of devices.

FIG. 6A is illustrated to include simulated window 604a, which is positioned on left wall 604. Simulated window 604a is a visual aid that indicates the location of a simulated passthrough of light (e.g., a window, a skylight, an opening within physical space 600, and/or a door) within physical space 600. In the embodiments described in relation to FIG. 6A, light sources 612 work in tandem to create a visual effect of physical space 600 including a passthrough of light at the location of simulated window 604a. In some embodiments, a simulated passthrough of light is a designated area on a surface of physical space 600 that light sources 612 emit light as passing through (e.g., entering physical space 600 and/or leaving physical space 600). In some embodiments, a surface is a wall, a roof, a ceiling, a surface of an object (e.g., desk 618 and/or another object), and/or a floor.

At FIG. 6A, light sources 612a and 612b (e.g., the left-most lights in FIG. 6A) are illuminating physical space 600, such that light is simulated as originating from simulated window 604a. At FIG. 6A, light sources 612a and 612b are powered on, which is indicated by the hatching shown over light sources 612a and 612b, while lights 612c and 612d are powered off, which is indicated by no hatching being shown over light sources 612c and 612d. In FIG. 6A, light sources 612a and light source 612b illuminate physical space 600 in a manner to emit light from the physical environment exterior to physical space 600 passing through left wall 604. For example, light source 612a and light source 612b at FIG. 6A emit light that extends from left wall 604 towards the center of physical space 600 as if a physical window was located at the location of simulated window 604a (e.g., as if a window were located on left wall 604) in FIG. 6A. The illumination of light would extend from left wall 604 because the weather in the physical environment exterior to physical space 600 is sunny and the time is 3:00 PM. Notably, the light simulated as passing through simulated window 604a would also change based on movement of one or more objects exterior to physical space 600, such as a tree blocking sunlight and/or a car moving exterior to left wall 604.

In some embodiments, a user can control where simulated window 604a is located. For example, in response to detecting an air gesture directed to left wall 604 (e.g., via a camera and/or cameras), light sources 612 emit light in manner to visually show simulated window 604a on left wall 604 at a particular location. In some embodiments, in response to detecting movement of an air gesture, light sources 612 emit light in one or more different manners to visually show simulated window 604a on left wall 604 at a changed position on left wall 604 and/or another surface and/or to visually show simulated window 604a moving. For example, in response to detecting a gaze input (e.g., via a camera and/or cameras) directed to left wall 604, light sources 612 position and/or move simulated window 604a to a particular location on left wall 604 (and/or another surface of physical space 600). As another example, in response to detecting a voice command directed to right wall 608 (e.g., “Make a window on that wall”), light sources 612 generate a simulated window on right wall 608 (e.g., as illustrated in FIG. 6B by simulated window 608a). As another example, in response to detecting a touch input (e.g., via a camera and/or cameras) directed to right wall 608 (e.g., a user touches a wall with a single finger, a hand, and/or traces a shape on a surface), light sources 612 place simulated window 604a on right wall 608. In some embodiments, a user can control where a simulated window is located using a different type of gesture, such as a mouse click, a voice command, and/or a gaze input.

In some embodiments, a user can control how a simulated window is shaped. For example, in response to detecting an air gesture, light sources 612 can emit light that changes the shape of a simulated window, such as changing the shape into a circle, a square, a triangle, a rectangle, and/or an oval. In some embodiments, the shape of the air gesture causes light sources 612 to emit light according to the shape of the air gesture. For examples, if a user hand was shaped into a circle, light sources 612 would emit light, such that a simulated window is changed into a shape of a circle. In some embodiments, a user can control how a simulated window is shaped using a different type of gesture, such as a mouse click, a voice command, and/or a gaze input. In some embodiments, a user can control one or more other properties of a simulated window, such as an amount of simulated light and/or size, using one or more techniques similar to those discussed above in relation to controlling the shape of simulated window 604a. At FIG. 6A, an input is detected. In some embodiments, the input is detected as being directed to right wall 608. In some embodiments, the input is detected by one or more of light sources 612 and/or one or more computing devices and/or communal devices in communication with light sources 612. In some embodiments, the input is an air gesture, a gaze input, a mouse click, a voice command, and/or a touch input.

At FIG. 6B, in response to detecting the input, light sources 612 change the way they are illuminating light to create (and/or generate) simulated window 608a, which is located on right wall 608. At FIG. 6B, in response to detecting the input, simulated window 604a no longer exists on left wall 604 and/or light sources 612 change the way they are illuminating light to remove simulated window 604a. At FIG. 6B, light sources 612c and 612d are currently illuminating physical space 600 (e.g., indicated by the hatching over light sources 612c and 612d) while light sources 612a and 612b are not currently illuminating physical space 600 (e.g., as indicated by no hatching over 612a and 612b). Thus, at FIG. 6B, light sources 612 adjust the illumination of light sources 612a-612d to change the properties of a simulated and/or to produce another simulated window. In some embodiments, in response to detecting the input, light sources 612 change the way they are illuminating light to create (and/or generate) simulated window 608a while also continuing to cause simulated window 608a to be visible. In some embodiments, multiple simulated windows are created on multiple surfaces. For example, one simulated window exists on the ceiling and another simulated window exists on a wall. Some embodiments, multiple simulated windows exist on the same surfaces. For example, two simulated windows are created on the same wall.

In some embodiments, one or more properties of simulated window 604a are changed and/or maintained in response to detecting the input. In some embodiments, in response to detecting the input, lights sources 612 change the way they are illuminating light to move simulated window 604a from left wall 604 to right wall 608, where simulated window 608a is simulated window 604a in a changed position.

It should be understood that, in some of these embodiments, the properties of simulated window 604a are changed to generate simulated window 608a to indicate that a different amount of light is passing through simulated window 608a because the location of simulated window 608a is at a different location with respect to the physical environment outside of physical space 600 at FIG. 6B from which simulated window 604a was in FIG. 6A. For example, at FIG. 6B, simulated window 608a is located on right wall 608. Because simulated window 608a is located at a different location than simulated window 604a, light sources 612 illuminate physical space 600 differently. For example, light sources 612c and 612d illuminate physical space differently from how light sources 612a and 612b illuminated physical space 600 at FIG. 6A because of the change of location (e.g., simulated window 604a was located towards the left and simulated window 608a is located towards the right (e.g., light sources 612a and 612b emit less light into physical space 600 through simulated window 604a than light sources 612c and 612d emit through simulated window 608a due to the time of day (e.g., 3:00 PM), as the sun is positioned closer towards the right)). To illustrate the difference, a denser hatching has been applied to light sources 612c and 612d at FIG. 6B than the hatching that was applied to light sources 612a and 612b to indicate that light sources 612c and 612d are illuminating physical space 600 with more light, less light, a different color of light, and/or a different characteristic (e.g., brightness, tone, coolness, softness, and/or shape) of light.

In FIGS. 6A and 6B, sun 614, visible through window 606a, is closer to the west (e.g., due to the current time of day (e.g., 3:00 PM)). Because of the location of sun 614 being closer to right wall 608, simulated light for simulated window 608a at FIG. 6B needs to be brighter than the simulated light for window 604a at FIG. 6A. Thus, at FIG. 6B, light sources 612c and 612d are illuminating physical space 600 with more light to generate simulated window 608a than light sources 612a and 612b illuminated to generate simulated window 604a.

In some embodiments, the location of a simulated window is automatically (e.g., without intervening input, such as input from a user) determined by light sources 612. For example, light sources 612 can generate a simulated window based on determined historical preferences and/or habits of a user, such as a user preference for softer and/or brighter light at a particular time of the day and/or a user preference for a particular type of light while the user is performing a particular activity, such as talking with a friend and/or sleeping. In some embodiments, the simulated window is generated based on light outside of a different physical space, such as a house and/or building in a different country than physical space 600.

In some embodiments, light sources 612 generate a simulated window based on the location of a celestial body (e.g., a sun, the moon, and/or another planet). For example, in response to detecting that the sun is directly over the current location of physical space 600 rising (e.g., via a camera and/or cameras), light sources 612 generate a simulated window on the ceiling of physical space 600. In some embodiments, the celestial body is simulated in the simulated window. As another example, if a simulated window is created in accordance with the location of the sun, light sources 612 emit much brighter light to simulate being able to see the sun through a window.

In some embodiments, light sources 612 generate a simulated window as covering the entirety of a surface (e.g., left wall 604, right wall 608, and/or ceiling 602) of physical space 600. In some embodiments, light sources 612 concurrently generate multiple simulated windows. For example, light sources 612 concurrently generate a simulated window on left wall 604 and ceiling 602. As another example, light sources 612 generate a simulated window on every available surface in physical space 600 (e.g., ceiling 602, left wall 604, middle wall 606, right wall 608, and/or floor 610). In some embodiments, light sources 612 do not generate a simulated window within physical space 600.

In some embodiments, light sources 612 emit light to simulate weather effects (e.g., clouds, rain, and/or wind) as a part of generating simulated window 608a. In some embodiments, the simulated weather effects can mimic the real-world weather conditions present at physical space 600. For example, based on a determination (e.g., made via a camera (e.g., cameras) and/or through communication with a server and/or an application (e.g., a weather application)) that the weather at the location of physical space 600 is a thunderstorm, light sources 612 output dim lighting and emit light in a manner that causes rain shadows and shadows indicating the occasional flash of lightning to be visible in physical space 600. In some embodiments, light sources 612 emit light to simulate weather effects in accordance with user preference. For example, in response to detecting input (e.g., an air gesture, a voice command, a gaze input, and/or a touch input), light sources 612 output lighting that mimics sunny conditions into physical space 600 though it is detected to be raining at physical space 600.

In some embodiments, light sources 612 simulate shadows (e.g., shadows) as a part of generating simulated window 604a and/or simulated window 608a. For example, at FIG. 6A, if there were a tree located outside of physical space 600 on the east side of physical space 600, light sources 612 would simulate the shadow of a tree as extending from left wall 604 towards the center of physical space 600. Because light source 612 simulates simulated window 604a as being located on the left most wall of physical space 600, simulated shadows will extend from left wall 604 towards the center of physical space 600. To the contrary, as illustrated in FIG. 6B, simulated window 608a is located on right wall 608. At FIG. 6B, because light source 612 simulates light as if it were extending towards the center of physical space 600 from right wall 608, simulated shadows will extend from right wall 608 towards the center of physical space 600. For example, at FIG. 6B, if there were a tree located outside of physical space 600 on the west side of physical space 600, light sources 612 would simulate the shadow of the tree as extending from right wall 608 towards the center of physical space 600. In some embodiments, light sources 612 simulate a shadow (e.g., shadows) when outputting light based on current weather conditions. For example, if simulated window 604a and/or simulated window 608a were located on ceiling 602, based on a determination e.g., via a camera (e.g., cameras) and/or through communication with a server and/or an application (e.g., a weather application)) that a cloud is passing over physical space 600, light sources 612 simulate the shadow of the cloud into physical space 600 (e.g., light sources 612 simulate the shape, size, and/or movement of the shadow of the cloud).

In some embodiments, while light sources 612 generate simulated window 608a, light sources 612 change the manner in which physical space 600 is illuminated based on the passage of time. For example, at FIG. 6B, as time elapses (e.g., the day transitions from the afternoon to the evening) light sources 612 gradually decrease the amount of light and/or the brightness of light coming from light sources 612 to mimic the changing conditions in the environment external to physical space. As an additional example, when light sources 612 emit light to simulate a simulated window on left wall 604 of physical space 600, in the morning, light sources 612 output bright light (e.g., because the sun rises in and/or is located in the east, the light will be brighter). As the day progresses e.g., and the earth rotates, light sources 612 decrease the brightness of the light (e.g., as the spatial orientation of physical space 600 and the sun change) moves away from left wall 604, light sources 612 emit less bright light).

In some embodiments, light sources 612 illuminate physical space 600 based on the current location of light sources 612. For example, if light sources 612 are located in Cupertino, California, light sources 612 can illuminate physical space 600 based on the current weather and/or lighting in the physical environment at Cupertino (e.g., if the light in Cupertino is bright and sunny, light sources 612 output bright and sunny light into physical space 600). In some embodiments, light sources 612 illuminate physical space 600 based on a different location than the current location of light sources 612. For example, if light sources 612 are located in Cupertino, California, light sources 612 can illuminate physical space 600 based on the current weather and/or lighting in the physical environment at Juneau, Alaska (e.g., if the light in Juneau is dim light) sources 612 output dim light into physical space 600 despite the light of Cupertino being bright and sunny). In some embodiments, light sources 612 illuminate physical space 600 based on a respective time at a location (e.g., different or same location at which light sources 612) are located that is different from the current time. In some embodiments, a user can choose the respective time via one or more inputs, such as a time in the past and/or a projected time in the future (e.g., based on one or more projections of future weather predicted to occur at a location).

In some embodiments, rather than actively emitting light to illuminate physical space 600, light sources 612 can allow light to pass through the physical space. For example, in a scenario where light sources 612 are a skylight, light sources 612 can change (e.g., such as a movable cover for one or more of light sources 612 changing position and/or a tint over one or more light sources 612 increasing and/or decreasing) to allow more or less light from the physical environment exterior to physical space 600 to enter into physical space 600. In some embodiments, other types of light sources than those described herein are recognized and can be implemented using one or more techniques.

FIG. 7 is a flow diagram illustrating a method (e.g., method 700) for simulating light passing through a physical opening in accordance with some embodiments. Some operations in method 700 are, optionally, combined, the orders of some operations are, optionally, changed, and some operations are, optionally, omitted.

As described below, method 700 provides an intuitive way for simulating light passing through a physical opening. Method 700 reduces the cognitive burden on a user, thereby creating a more efficient human-machine interface. For battery-operated computing devices, enabling a user to cause the simulation of light passing through a physical opening faster and more efficiently conserves power and increases the time between battery charges.

In some embodiments, method 700 is performed at a computer system (e.g., as described above in relation to FIGS. 6A-6B) that is in communication with a light source (e.g., 612) (e.g., an illumination device, a point light source, a spotlight, and/or one or more light sources) and an input device (e.g., as described above in relation to FIGS. 6A-6B) (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device. In some embodiments, the light source is not physically connected to and/or coupled to the computer system.

The computer system detects (702), via the input device, a request to illuminate a physical space (e.g., 600) (e.g., a physical environment, a room, an office, and/or a building) (e.g., as described above in relation to FIG. 6A-6B). In some embodiments, detecting the request includes detecting an input (e.g., a tap gesture, a long press gesture, a verbal request and/or command, a physical button press, a pointing input and/or air gesture, and/or a rotation of a physical input mechanism) corresponding to the request. In some embodiments, detecting the request includes receiving a message from another computer system, the message indicating that the request was received by the other computer system.

In response to (704) detecting the request to illuminate the physical space (e.g., 600) (e.g., as described above in relation to FIGS. 6A-6B) and in accordance with a determination that a first portion (e.g., 602, 604, 604a, 606, and/or 608) (e.g., an area, a portion, and/or a part) of the physical space (e.g., 600) (e.g., a portion of a ceiling and/or a wall) is set (e.g., defined, preset, and/or configured) as a passthrough of light (e.g., a window, an opening, and/or a location for which light is set to originate, passthrough, and/or otherwise be provided), the computer system provides (706), via the light source (e.g., 612a-612d), illumination in a first manner (e.g., a location, a color, an intensity, and/or a size of illumination) (e.g., based on the first portion of the physical space being set as a passthrough of light) (e.g., as described above in relation to FIGS. 6A-6B). In some embodiments, providing the illumination in the first manner includes activating the light source. In some embodiments, providing the illumination in the first manner includes changing light output by the light source. In some embodiments, providing the illumination in the first manner includes sending a request to the light source to modify light being output by the light source. In some embodiments, the illumination is provided in the first manner until a request is received to change or stop providing the illumination in the first manner.

In response to (704) detecting the request to illuminate the physical space and in accordance with a determination that the first portion (e.g., 602, 604, 606, 606a, and/or 608) of the physical space (e.g., 600) is not set as a passthrough of light, the computer system forgoes (708) providing (e.g., via the light source) illumination in the first manner (e.g., without, in some embodiments, providing illumination in another manner or, in some embodiments, while providing illumination in a different manner) (e.g., as described above in relation to FIGS. 6A-6B) (e.g., 604a and/or 608a). Selectively providing illumination in the first manner depending on whether the first portion is set as a passthrough of light allows the computer system to customize how the physical space is illuminated, thereby reducing the number of inputs needed to perform an operation and/or performing an operation when a set of conditions has been met without requiring further user input.

In some embodiments, the first portion (e.g., 602, 604, 606, 606a, and/or 608) of the physical space (e.g., 600) corresponds to (e.g., is, includes, is formed out of) a first set of one or more physical structures (e.g., a solid structure) (e.g., a roof) (e.g., 602, 604, 606, 606a, and/or 608) that covers (e.g., covers the top of the physical space and does not cover the sides of the physical space) at least a portion of the physical space (e.g., 600) (e.g., covers less than the entirety of the physical space and/or covers the entirety of the physical space). In some embodiments, the first set of one or more physical structures does not form at least a portion of the perimeter of the physical space. Having the first portion corresponding to a first set of one or more physical structures that covers at least a portion of the physical space allows the computer system to simulate a type of physical opening (e.g., a skylight and/or a window) without there actually being the physical opening in the physical space, thereby reducing the number of inputs needed to perform an operation and/or performing an operation when a set of conditions has been met without requiring further user input.

In some embodiments, a second set of one or more physical structures (e.g., a solid structure) (e.g., a wall and/or a separator) (e.g., 602, 604, 606, 606a, and/or 608) that form at least a portion of a perimeter of the physical space (e.g., 608) is not set as a passthrough of light. In some embodiments, the second set of one or more physical structures surrounds the perimeter of the physical space. In some embodiments, the second set of one or more physical structures surrounds a portion of the perimeter of the physical space. In some embodiments, the second set of one or more physical structures are set as a passthrough of light. In some embodiments, both the first set of one or more physical structures and the second set of one or more physical structures are set as a passthrough of light. Having a second set of one or more physical structures that form at least a portion of the perimeter of the physical space not being set as a passthrough of light allows the computer system to create an appearance concerning the physical space, thereby reducing the number of inputs needed to perform an operation and/or performing an operation when a set of conditions has been met without requiring further user input.

In some embodiments, the first portion (e.g., 602, 604, 606, 606a, and/or 608) corresponds to (e.g., is, includes) a third set of one or more structures (e.g., 602, 604, 606, 606a, and/or 608) (e.g., walls and/or windows) that form at least a portion of a perimeter (e.g., walls, room dividers, and or partitions) of the physical space (e.g., 600). In some embodiments, the third set of one or more physical structures surrounds the perimeter of the physical space. In some embodiments, the third set of one or more physical structures surrounds a portion of the perimeter of the physical space. Having the first portion corresponding to a third set of one or more structures that form at least a portion of the perimeter of the physical space allows the computer system to simulate a window on a wall without their actually being a physical window on the wall or a particular portion of the wall in the physical space, thereby reducing the number of inputs needed to perform an operation and/or performing an operation when a set of conditions has been met without requiring further user input.

In some embodiments, providing the illumination in the first manner includes providing, via the light source (e.g., 612), a simulation (e.g., imitation, copy, replication, and/or reproduction) of a weather event (e.g., as described above in relation to FIGS. 6A-6B) (e.g., clouds, rain, wind, tornado, hail, hurricane, and/or tornado) (e.g., a weather effect and/or an element of weather). In some embodiments, the simulation of the weather event corresponds to the past, current, and/or future weather at a location corresponding to the physical space (e.g., weather outside of the physical space but at the same location). In some embodiments, the simulation of the weather event corresponds to the past, current, and/or future weather at another physical space that is external to the physical space. In some embodiments, the simulation of the weather event corresponds to the past, current, and/or future weather at another location different from a location corresponding to the physical space. In some embodiments, in response to detecting the request to illuminate the physical space, the computer system causes, via a set of one or more playback devices, output of audio that mimics the weather event while providing the simulation of the weather event. Selectively providing a simulation of a weather event allows the computer system to inform a user of weather events and/or provide a particular ambiance, thereby reducing the number of inputs needed to perform an operation, providing improved feedback, and/or performing an operation when a set of conditions has been met without requiring further user input.

In some embodiments, before (e.g., and/or while) detecting the request to illuminate the physical space (e.g., 600), the computer system detects, via the input device, an input (e.g., input, such as swipe input, tap input, voice command, gaze, and/or air gesture) that corresponds to selection of the first portion (e.g., one or more walls, a portion of a wall, a window, a door, the roof, and/or a floor) of the physical space (e.g., as described above in relation to FIGS. 6A-6B). In some embodiments, in response to detecting the input that corresponds to selection of the first portion of the physical space, the computer system sets (e.g., assigns, designates, establishes, defines, and/or appoints) the first portion of the physical space as a passthrough of light (e.g., as described above in relation to FIGS. 6A-6B). In some embodiments, the first portion of the physical space is set as a passthrough of light for a predetermined period of time (e.g., 1-60 seconds). In some embodiments, the first portion of the physical space is set as a passthrough of light for an indefinite period of time (e.g., until detecting an input corresponding to selection of another portion and/or unsetting the first portion of the physical space as a passthrough of light). In some embodiments, the first portion of the physical space corresponds to two or more different discrete areas of the physical space. Setting the first portion of the physical space as a passthrough of light in response to detecting the input that corresponds to selection of the first portion of the physical space allows a user to change how the physical space is illuminated via input, thereby providing additional input mechanisms without cluttering the user interface and performing an operation when a set of conditions has been met without requiring further user input.

In some embodiments, the input that corresponds to selection of the first portion of the physical space (e.g., 600) includes (and/or is) an air gesture (e.g., an air tap, air swipe, tapping index finger and thumb, and/or rotation of hand) (e.g., as described above in relation to FIGS. 6A-6B). Having the input that corresponds to selection of the first portion including an air gesture allows a user to gesture in a direction to identify where to make a passthrough of light instead of requiring spoken and/or other types of input to define an area, thereby providing improved feedback to the user, reducing the number of inputs needed to perform an operation, and/or performing an operation when a set of conditions has been met without requiring further user input.

In some embodiments, the first portion (e.g., 602, 604, 606, 606a, and/or 608) is set as a passthrough of light without detecting input from a user (e.g., automatically and/or without detecting user input) (e.g., as described above in relation to FIGS. 6A-6B). Having the first portion be set as a passthrough of light without detecting input from a user allows the computer system to pick where in the physical space makes sense for a current illumination goal rather than requiring the user to provide one or more inputs to explicitly indicate where to add a passthrough of light, thereby providing improved feedback to the user, reducing the number of inputs needed to perform an operation, and/or performing an operation when a set of conditions has been met without requiring further user input.

In some embodiments, in conjunction with (e.g., after and/or in response to) detecting the request to illuminate the physical space (e.g., as described above in relation to FIGS. 6A-6B) and in accordance with a determination that a first celestial body (e.g., 614) (e.g., sun, moon, and/or one or more stars) is positioned at a first location (e.g., relative to the physical space (e.g., and/or the computer system) (e.g., the first celestial body is north, east, west, and/or south of the physical space) (e.g., the first celestial body is at 10 degrees, 90 degrees, and/or 120 degrees relative to the physical space)), the computer system sets a second portion of the physical space as a passthrough of light (e.g., 602, 604, 606, 606a, and/or 608). In some embodiments, in conjunction with detecting the request to illuminate the physical space and in accordance with the determination that the first celestial body is positioned at the first location, the computer system provides, via the light source, illumination in a second manner (e.g., a location, a color, an intensity, and/or a size of illumination) (e.g., based on the second portion of the physical space being set as a passthrough of light) (e.g., 602, 604, 606, 606a, and/or 608). In some embodiments, in conjunction with detecting the request to illuminate the physical space and in accordance with the determination that the first celestial body is positioned at the first location, the computer system provides, via the light source, illumination in the second manner without setting the second portion of the physical space as a passthrough of light. In some embodiments, in conjunction with detecting the request to illuminate the physical space and in accordance with a determination that the first celestial body (e.g., 614) is positioned at a second location (e.g., relative to the physical space (e.g., and/or the computer system) (e.g., the first celestial body is north, east, west and/or south of the physical space)) different from the first location (e.g., 602, 604, 606, 606a, and/or 608), the computer system sets a third portion of the physical space as a passthrough of light, wherein the third portion is different from the second portion (e.g., 602, 604, 606, 606a, and/or 608). In some embodiments, in conjunction with detecting the request to illuminate the physical space and in accordance with the determination that the first celestial body is positioned at the second location different from the first location, the computer system provides, via the light source, illumination in a third manner (e.g., a location, a color, an intensity, and/or a size of illumination) (e.g., based on the third portion of the physical space being set as a passthrough of light) different from the second manner (e.g., 602, 604, 606, 606a, and/or 608). In some embodiments, in conjunction with detecting the request to illuminate the physical space and in accordance with the determination that the first celestial body is positioned at the second location, the computer system provides, via the light source, illumination in the third manner without setting the third portion of the physical space as a passthrough of light. In some embodiments, after providing illumination in the second manner when the first celestial body is positioned at the first location, the computer system provides, via the light source, illumination in the third manner when the first celestial body is positioned at the second location. In some embodiments, after providing illumination in the second manner when the first celestial body is positioned at the first location, the computer system sets the third portion of the physical space as a passthrough of light when the first celestial body is positioned at the second location. In some embodiments, the third region overlaps with the second region. In some embodiments, the third region does not overlap with the second region. In some embodiments, the third region and the second region are located at opposite sides of the physical space. In some embodiments, the third region and the second region are located on the same side of the physical space. Providing illumination in different manners depending on a position of a celestial body allows the computer system to adjust illumination as the celestial body moves in the sky relative to a location, thereby providing improved feedback to the user, reducing the number of inputs needed to perform an operation, and/or performing an operation when a set of conditions has been met without requiring further user input.

In some embodiments, providing, via the light source, illumination in the first manner includes: simulating (e.g., imitating, mimicking, and/or mocking) light as passing through (e.g., originating from, emanating from, and/or spreading from) the first portion (e.g., 602, 604, 606, 606a, and/or 608) of the physical space (e.g., 600) (e.g., light is simulated as entering and/or exiting the physical space through the first portion) (e.g., 602, 604, 606, 606a, and/or 608) and forgoing simulating light as passing through (e.g., originating from, emanating from, spreading from) a fourth portion (e.g., 602, 604, 606, 606a, and/or 608) of the physical space (e.g., 600). In some embodiments, the fourth portion is different from the first portion (e.g., light is not simulated as entering and/or exiting the physical space through the third respective portion) (e.g., 602, 604, 606, 606a, and/or 608). In some embodiments, providing, via the light source, illumination in the first manner includes simulating light as passing through the first portion of the physical space and the fourth portion of the physical space. Simulating light as passing through the first portion but not the fourth portion allows the computer system to create different illumination effects depending on where passthroughs of light are set, thereby performing an operation when a set of conditions has been met without requiring further user input.

In some embodiments, providing, via the light source, illumination in the first manner include simulating (e.g., imitating, mimicking, mocking, and/or imitating) a beam of light (e.g., a column of light, a streak of light, and/or a flare of light) as passing through (e.g., originating from, emanating from, spreading from) the first portion of the physical space (e.g., light is simulated as entering and/or exiting the physical space via the first portion of the physical space) (e.g., 602, 604, 606, 606a, and/or 608) (e.g., as described above in relation to FIGS. 6A-6B). In some embodiments, the beam of light pulsates. In some embodiments, the beam of light tracks the movement of an object (e.g., a celestial object) that is not positioned within the physical space. In some embodiments, the beam of light includes two or more colors. In some embodiments, the beam of light is one color. Simulating a beam of light as passing through the first portion of the physical space allows the computer system to simulate light coming through a passthrough of light without actual light passing through the first portion, thereby performing an operation when a set of conditions has been met without requiring further user input.

In some embodiments, in response to detecting the request to illuminate the physical space (e.g., 600) and in accordance with a determination that a fifth portion (e.g., 602, 604, 606, 606a, and/or 608) of the physical space is set as a passthrough of light (e.g., light is simulated as entering and/or exiting the physical space via the third portion of the physical space) (e.g., and the first portion of the physical space is not set as the passthrough of light), the computer system provides, via the light source (e.g., 612), illumination in a fourth manner (e.g., a location, a color, an intensity, and/or a size of illumination) different from the first manner, wherein the fifth portion is different from the first portion (e.g., 602, 604, 606, 606a, and/or 608) (e.g., as described above in relation to FIGS. 6A-6B). Providing illumination in a different manner when a different portion of the physical space is set as a passthrough of light allows the computer system to adapt illumination based on where passthroughs of light are set, thereby providing improved feedback to the user, reducing the number of inputs needed to perform an operation, and/or performing an operation when a set of conditions has been met without requiring further user input.

In some embodiments, in response to detecting the request to illuminate the physical space (e.g., 600) and in accordance with a determination that a sixth portion (e.g., 602, 604, 606, 606a, and/or 608) of the physical space and a seventh portion of the physical space are set as a passthrough of light (e.g., light is simulated as entering and/or exiting the physical space via the sixth portion and the seventh portion of the physical space), the computer system provides, via the light source, illumination in a fifth manner (e.g., based on multiple passthroughs of light, including the sixth portion and the seventh portion) different from the first manner, wherein the seventh portion is separate from the sixth portion (e.g., the physical space includes another area between the seventh portion and the sixth portion) (e.g., as described above in relation to FIGS. 6A-6B). In some embodiments, the sixth portion of the physical space does not overlap with and is not adjacent to the seventh portion of the physical space. Providing illumination in a different manner when multiple portions of the physical space are each set as a passthrough of light allows the computer system to produce complex illumination with multiple virtual sources without requiring there to be actual physical windows and/or other physical mechanisms for allowing light to passthrough, thereby providing improved feedback to the user, reducing the number of inputs needed to perform an operation, and/or performing an operation when a set of conditions has been met without requiring further user input.

In some embodiments, in response to detecting the request to illuminate the physical space (e.g., 600) and in accordance with a determination that a current setting (e.g., of the light source and/or the computer system) does not use one or more passthroughs of light for illumination (e.g., the physical space can include a portion of the physical space that is set as a passthrough of light), the computer system provides, via the light source, illumination in a sixth manner (e.g., as described above in relation to FIGS. 6A-6B) (e.g., a location, a color, an intensity, and/or a size of illumination) different from the first manner. In some embodiments, providing illumination in the sixth manner includes providing, via the light source, illumination generally and/or not in a specific direction in the physical space. In some embodiments, providing illumination in the sixth manner includes providing, via the light source, illumination in a particular direction (e.g., downward and/or in a direction parallel with respect to the light source). In some embodiments, providing illumination in the first manner is based on one or more objects within the physical space (e.g., the illumination takes into account the one or more objects such that a simulated shadow is created when an object is present). In some embodiments, providing illumination in the sixth manner is not based on an object within the physical space. Providing illumination in a different manner when a current setting does not use passthroughs of light allows a user to establish different situations when different types of illumination are to be used, thereby providing improved feedback to the user and/or performing an operation when a set of conditions has been met without requiring further user input.

In some embodiments, in response to detecting the request to illuminate the physical space (e.g., 600) and in accordance with a determination that the physical space does not have a portion (e.g., 602, 604, 606, 606a, and/or 608) of the physical space set as a passthrough of light, the computer system provides, via the light source, illumination in a seventh manner (e.g., a location, a color, an intensity, and/or a size of illumination) different from the first manner (and/or forgoes providing illumination in the first manner) (e.g., as described above in relation to FIGS. 6A-6B). In some embodiments, in response to detecting the request to illuminate the physical space and in accordance with a determination that the physical space does not have a portion of the physical space set as a passthrough of light, the computer system ceases and/or forgoes providing, via the light source, illumination. In some embodiments, providing illumination in the seventh manner includes providing, via the light source, illumination generally and/or not in a specific direction in the physical space. In some embodiments, providing illumination in the seventh manner includes providing, via the light source, illumination in a particular direction (e.g., downward and/or in a direction parallel with respect to the light source). In some embodiments, providing illumination in the seventh manner is not based on an object within the physical space. Providing illumination in a different manner when the physical space does not have a portion of the physical space set as a passthrough of light allows a user to establish different situations when different types of illumination are to be used, thereby providing improved feedback to the user and/or performing an operation when a set of conditions has been met without requiring further user input.

In some embodiments, after (e.g., and/or while) providing, via the light source (e.g., 612), illumination in the first manner, the computer system detects, via the input device, an input (e.g., input, such as swipe input, tap input, voice command, gaze input, and/or air gesture) corresponding to a request to set an eighth portion (e.g., 602, 604, 606, 606a, and/or 608) of the physical space (e.g., 600) (e.g., a wall, a roof, a ceiling, and/or a floor of the physical space) as a passthrough of light (e.g., light is simulated as entering and/or exiting the physical space through the passthrough). In some embodiments, in response to detecting the input corresponding to the request to set the eighth portion of the physical space as a passthrough of light, the computer system provides, via the light source, illumination in an eighth manner (e.g., a location, a color, an intensity, and/or a size of illumination) (e.g., and ceases to provide illumination in the first manner) (e.g., based on the first portion and/or the eighth portion of the physical space being set as a passthrough of light) (e.g., 602, 604, 606, 606a, and/or 608) different from the first manner. Providing illumination in a different manner in response to detecting the input corresponding to the request to set the eighth portion of the physical space as a passthrough of light allows a user to add new passthroughs of light to change illumination, thereby providing improved feedback to the user and/or performing an operation when a set of conditions has been met without requiring further user input.

In some embodiments, providing, via the light source, illumination in the eighth manner includes simulating (e.g., imitating, copying, replicating, and/or reproducing) light as passing through (e.g., originating from, emanating from, and/or spreading from) the first portion (e.g., 602, 604, 606, 606a, and/or 608) of the physical space and the eighth portion of the physical space (e.g., 600). In some embodiments, an equal amount of illumination is simulated as passing through the first portion of the physical space and the eighth portion of the physical space. In some embodiments, more or less illumination is simulated as passing through the first portion of the physical space than the eighth portion of the physical space. In some embodiments, the same color of illumination is simulated as passing through the first portion of the physical space and the eighth portion of the physical space. In some embodiments, different colors of illumination are simulated as passing through the first portion of the physical space and the eighth portion of the physical space. Simulating light as passing through previous passthroughs of light in addition to new passthroughs of light allows the computer system to create illuminations that are based on concepts of virtual passthroughs of light, thereby providing improved feedback to the user, reducing the number of inputs needed to perform an operation, and/or performing an operation when a set of conditions has been met without requiring further user input.

In some embodiments, providing, via the light source, illumination in the eighth manner includes simulating (e.g., imitating, copying, replicating, and/or reproducing) light as passing through (e.g., originating from, emanating from, spreading from) the eighth portion (e.g., 602, 604, 606, 606a, and/or 608) of the physical space and not the first portion of the physical space (e.g., 600).

In some embodiments, after providing (e.g., and/or while), via the light source (e.g., 612), illumination in the first manner, the computer system detects an expiration of time (e.g., 0.1-360 minutes) (e.g., as described above in relation to FIG. 6B). In some embodiments, in response to detecting the expiration of time (e.g., and without detecting user input), the computer system provides, via the light source (e.g., 612), illumination in a ninth manner (e.g., a location, a color, an intensity, and/or a size of illumination) different from the first manner (e.g., as described above in relation to FIG. 6B) (e.g., the light has a different set of characteristics (e.g., brightness, tone, hue, and/or frequency of pulsating when the light source provides illumination in the ninth manner in contrast to when the light source provides illumination in the first manner)). In some embodiments, the light source continues to provide illumination in the first manner after detecting the expiration of time. In some embodiments, the light source outputs, via the light source, illumination in the ninth manner in response to detecting an input. Providing illumination in a different manner as time passes allows the illumination to be dynamic and/or change over time without requiring distinct user inputs to change the illumination, thereby providing improved feedback to the user, reducing the number of inputs needed to perform an operation, and/or performing an operation when a set of conditions has been met without requiring further user input.

In some embodiments, in accordance with a determination that the first portion (e.g., 602, 604, 606, 606a and/or 608) of the physical space (e.g., 600) is at (e.g., positioned at) a first location within the physical space, providing illumination in the first manner includes forming a first shadow (e.g., as described above in relation to FIG. 6B). In some embodiments, the first shadow is based on one or more objects that are positioned within the physical space and/or another physical space external to the physical space. In some embodiments, in accordance with a determination that the first portion of the physical space is at (e.g., positioned at) a second location within the physical space, providing illumination in the first manner includes forming a second shadow different from the shadow (e.g., without forming the first shadow) (e.g., as described above in relation to FIG. 6B). In some embodiments, the second shadow is based on the one or more objects that are positioned within the physical space and/or the other physical space external to the physical space. In some embodiments, the second location is different (and/or separate) from the first location (e.g., as described above in relation to FIG. 6B). In some embodiments, the first shadow and/or the second shadow are moved based on movement of the one or more objects within the physical space and/or the other physical space external to the physical space. Simulating different shadows based on where the first portion is located allows illumination to take into account the physical space and one or more objects in the physical space, thereby providing improved feedback to the user and/or performing an operation when a set of conditions has been met without requiring further user input.

In some embodiments, providing illumination in the first manner is based on a current (e.g., present) location of the computer system (e.g., different current locations cause illumination to be provided in different manners) (e.g., as described above in relation to FIG. 6B). In some embodiments, providing illumination in the first manner is based on a previous and/or future location of the computer system. In some embodiments, the current location of the computer system is within the physical space. In some embodiments, the current location of the computer system is outside of the physical space. Providing illumination based on the current location of the computer system allows the computer system to reflect current conditions (e.g., even when the physical space might not physically include certain passthroughs of light to reflect such current conditions), thereby providing improved feedback to the user and/or performing an operation when a set of conditions has been met without requiring further user input.

In some embodiments, providing illumination in the first manner is based on another location different from a current location (e.g., present) of the computer system (e.g., as described above in relation to FIG. 6B). In some embodiments, the other location is geographically different from the physical space. Providing illumination based on another location different from the current location of the computer system allows the computer system to artificially create an appearance that the physical space is in a different geographical location using illumination, thereby providing improved feedback to the user and/or performing an operation when a set of conditions has been met without requiring further user input.

In some embodiments, providing, via the light source, illumination in the first manner includes: outputting, via a first light source (e.g., 612a-612d) (e.g., an external light source, an illumination device, a point light source, a spotlight, and/or one or more light sources), illumination (e.g., as described above in relation to FIGS. 6A-6B) and outputting, via a second light source (e.g., 612a-612d) (e.g., an external light source, an illumination device, a point light source, a spotlight, and/or one or more light sources) different (and/or separate) from the first light source, illumination (e.g., as described above in relation to FIGS. 6A-6B). In some embodiments, the first light source and the second light source are the same type of light source. In some embodiments, the first light source and the second light source are different types of light sources. In some embodiments, the first light source and the second light source output the same amount and/or type of illumination. In some embodiments, the first light source and the second light source output different amounts and/or types of illumination. In some embodiments, the first light source and the second light source output different colors of light. In some embodiments, the first light source and the second light source output the same color of light.

Note that details of the processes described above with respect to method 700 (e.g., FIG. 7) are also applicable in an analogous manner to other methods described herein. For example, method 700 optionally includes one or more of the characteristics of the various methods described herein. For example, a physical space can be illuminated using one or more techniques described above in relation to method 700, where the manner in which the physical space is illuminated can be selected based on a selected window size using one or more techniques described herein in relation to method 900. For brevity, these details are not repeated herein.

FIGS. 8A-8B illustrate exemplary environments for simulating different amounts of light passing through a physical opening in accordance with some embodiments. The user interfaces in these figures are used to illustrate the processes described below, including the processes in FIG. 9.

FIG. 8A illustrates physical space 600 that includes one or more features and/or components as described above in relation to FIGS. 6A-6B, including ceiling 602, middle wall 606, and desk 618. As illustrated in FIG. 8A, middle wall 606 includes window 606a and clock 606b. In addition, clock 606b displays that the current time is 3:00 PM, and sun 614 is visible through window 606a. Window 606a is a window where light passes through from the physical environment that is exterior to physical space 600 into physical space 600. At FIG. 8A, sun 614 is a part of the physical environment that is exterior to physical space 600, where the light from sun 614 is currently passing through window 606a and impacts the physical environment interior to physical space 600. In some embodiments, physical space 600 is a physical space of an area in another type of building, such as a hotel, an office, and/or a business.

As illustrated in FIGS. 8A-8B, ceiling 602 includes light sources 612, which are physically connected to ceiling 602. Light sources 612 includes light sources 612a-612d, which are used to illuminate physical space 600. In some embodiments, light sources 612 are in communication with one or more other devices (e.g., computer systems and/or processing devices). For example, light sources 612 can communicate with one or more sensor devices directly and/or indirectly via one or more computing devices that are in communication with the one or more sensor devices. In some embodiments, the one or more sensor devices detect changes and/or the level of one or more properties of a physical space, such as an amount of ambient light and/or movement in the environment. As another example, light sources 612 can communicate with one or more processing devices that process sensor data, determine illumination levels, and/or process inputs that assist and/or instruct light sources 612 to emit light as described herein. For ease of explanation, various operations (e.g., outputting illumination, detecting input, and/or determining properties) are described below as being performed by light sources 612. However, it should be recognized that one or more of the operations described below is performed by a device different from light sources 612, such as one or more personal computing devices (e.g., a phone, a tablet, a laptop, a desktop, a head-mounted display (HMD) device, and/or a wearable device) and/or communal devices (e.g., a smart speaker, a television, a router, and/or a hub). In some embodiments, the one or more computing devices and/or communal devices include one or more features and/or components of devices 100, 300, and/or 500 as described above. Unless otherwise noted explicitly, this description should not be construed as limiting the scope of such operations to be performed by a single device (e.g., light sources 612) or a particular combination of devices.

To illustrate that a light source is powered on (e.g., powered up, awake, emitting a certain amount of light, and/or in an active state), light sources 612 include diagonal hatching. At FIG. 8A, light sources 612 detect an input that defines the size of window 606a. For example, a verbal input (e.g., “Double the size of my window”) and/or an air gesture (e.g., a user traces a shape in the air with their finger which defines the size of window 606a). In some embodiments, another input defines the size of window 606a (such as a gaze input, a mouse click, and/or a touch input).

As illustrated in FIG. 8B, in response to detecting an input at FIG. 8A, light sources 612 generate simulated window 800 corresponding to an input (e.g., and/or a captured image). In FIG. 8B, light sources 612 have an appearance of horizontal hatching to signify that they are emitting light in a different manner from which light sources 612 emitted light in FIG. 8A. Thus, at FIG. 8B, in response to detecting the input, light sources 612 have changed the way they are emitting light. At FIG. 8B, light sources 612 are emitting light in such a manner that causes simulated window 800 to appear in physical space 600. Simulated window 800 is positioned around window 606a and the generation of simulated window 800 makes it appear as though more light is being passed through window 606a from the physical environment that is exterior to physical space 600. In some embodiments, light sources 612 emit more light into physical space 600 at FIG. 8B than light sources 612 emitted at FIG. 8A. In some embodiments, at FIG. 8B, light sources 612 emit light to imitate the amount of light that would pass through window 606a if window 606a were larger than window 606a is at FIG. 8B. In some embodiments, rather than actively emitting light to illuminate physical space 600, light sources 612 can allow light to pass through the physical space. For example, in a scenario where light sources 612 are a skylight, light sources 612 can change (e.g., such as a movable cover for one or more of light sources 612 changing position and/or a tint over one or more light sources 612 increasing and/or decreasing) to allow more or less light from the physical environment exterior to physical space 600 to enter into physical space 600. In some embodiments, other types of light sources than those described herein are recognized and can be implemented using one or more techniques.

In some embodiments, a window is detected in response to capturing an image of a physical space. In some embodiments, a computer system captures an image of a physical space that includes a window using a camera that is in communication with the computer system. In some embodiments, the computer system is a personal computer system, a smart phone, a smart watch, a wearable device, a tablet, a laptop computer, a fitness tracking device, a head-mounted display (HMD) device, and/or a desktop computer. In some embodiments, an image is captured automatically without a request from a user to capture the image. In some embodiments, an image is captured manually (e.g., via an input) and/or with a request from a user to capture the image. In some embodiments, the level of simulated light of a simulated window is based on a captured image. For example, if a computer system captures an image of a window that provides bright light, the computer system makes a determination that the light from the window is bright. In response to making a determination of the brightness level of the light coming from the window, light sources 612 simulate bright light to match the bright light coming from the window. In some embodiments, the same sized window is illuminated with different amounts of simulated light based on external factors, such as location, weather, and/or time of day. For example, light sources 612 simulate bright light on a window in the morning and dim light on the same window in the evening. In another example, light sources simulate lighting with a lower level of brightness on a small window (e.g., to replicate the expected amount of light that could come from a smaller-sized window) and simulate lighting with a higher level of brightness on a large window (e.g., to replicate the expected amount of light that could come from a larger-sized window).

In FIG. 8B of this disclosure, reference is made to an area that is illustrated by a dashed line border. The dashed line border is a visual aid that illustrates a simulated window. A simulated window is a designated area on a window that light sources 612 define to change (e.g., modify and/or alter) a physical window (e.g., increase the size of, increase the brightness of, decrease the size of, decrease the brightness of, and/or change the shape of). When a simulated window has been generated, light sources 612 emit light into physical space 600 as if the simulated window were a real window. For example, as will be seen below, in a scenario where a simulated window is larger than (increases the size of) a window, light sources 612 emit more light into physical space 600 to simulate there being a larger window in physical space 600.

In some embodiments, light sources 612 can change an existing simulated window. For example, in response to detecting an input, light sources 612 can grow, shrink, increase brightness, decrease brightness, change shape, and/or change location of a simulated window. In some embodiments, one simulated window is changed at one time. For example, light sources 612 increase the size of one simulated window over a window in a physical space in response to detecting an input. In some embodiments, multiple simulated windows are changed at one time. For example, light sources 612 increase the size of multiple simulated windows in a physical space. In some embodiments, a simulated window is changed as many times as needed. In some embodiments, a simulated window is only able to be changed a certain number of times. In some embodiments, one or more changes are only made on the simulated window where an input was directed. For example, in response to detecting an air gesture directed to a simulated window and/or another physical window, light sources 612 only apply changes to the simulated window and/or a simulated window representative of the physical window (e.g., the relationship of window 606a and simulated window 800).

In some embodiments, the level of illumination depends on the size of the simulated window. For example, when a determination is made that a simulated window should be (e.g., as directed by a user) generated to make a physical window appear larger, light sources 612 emit brighter light than the light provided by the physical window. In another example, when a determination is made that a simulated window should be (e.g., as directed by a user) generated to make a physical window appear smaller, light sources 612 emit dimmer light than the light provided by the physical window. In some embodiments, in response to detecting an input corresponding to a request to increase the amount of light passing through a physical window, light sources 612 concurrently illuminate light with a greater level of intensity. In some embodiments, the intensity is increased as the input is detected and/or as movement of the input is detected. In some embodiments, when a determination is made that a physical window should passthrough light as if the physical window was below a threshold size, light sources 612 cease to emit light. In some embodiments, a user can delete and/or reconfigure a simulated window (and/or a simulate an effect) caused by light sources 612 emitting light.

In some embodiments, light sources 612 generate a simulated window based on the current location of a physical space. For example, when a determination is made that the physical environment external to physical space 600 is sunny, light sources 612 emit light to simulate a greater amount of light passing through simulated window 606a than the light emitted to simulate the amount of light passing through window 606a when the determination is made that the physical environment external to physical space 600 is not sunny, such as during the night. In some embodiments, light sources 612 emit light to simulate light passing through window 606a that is based on a physical environment of another location. For example, light sources 612 can emit dim light based on a dark environment in Alaska, even when physical space 600 is located in California where it is sunny. In some embodiments, the amount of light emitted via light sources 612 causes the simulated window 800 to change based on the passage of time and/or the passage of weather with respect to a physical environment and/or location. For example, in the morning, light sources 612 can emit light to simulate brighter light to match a sunrise and, in the evening, emit light to simulate darker light to match a sunset. As another example, if the outside weather is detected to be a thunderstorm, light sources 612 emit light to simulate dim light that includes one or more rain shadows and/or flashes of lightning. In some embodiments, light sources 612 emit light to simulate a shadow in the physical environment external to physical space 600. For example, when a determination is made that a shadow has been created in the physical environment external to physical space 600 (e.g., if a cloud were to pass in front of sun 614 and/or a car was to pass by window 606a), light sources 612 can emit light to simulate a shadow and/or less light being passed through the environment while the shadow exist in the physical environment.

FIG. 9 is a flow diagram illustrating a method (e.g., method 900) for simulating different amounts of light passing through a physical opening in accordance with some embodiments. Some operations in method 900 are, optionally, combined, the orders of some operations are, optionally, changed, and some operations are, optionally, omitted.

As described below, method 900 provides an intuitive way for simulating different amounts of light passing through a physical opening. Method 900 reduces the cognitive burden on a user, thereby creating a more efficient human-machine interface. For battery-operated computing devices, enabling a user to cause the simulation of different amounts of light passing through a physical opening faster and more efficiently conserves power and increases the time between battery charges.

In some embodiments, method 900 is performed at a computer system that is in communication with a light source (e.g., 612a-612d and/or 612) (e.g., an illumination device, a point light source, a spotlight, and/or one or more light sources) (and/or a set of one or more light sources) and an input device (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device. In some embodiments, the light source is not physically connected to and/or coupled to the computer system.

The computer system detects (902), via the input device, a request to change a size of a physical window (e.g., 606a) (e.g., a physical opening, a physical object that light is able to pass through, and/or a physical object that light is able to pass through from an external environment to an internal environment) in a physical space (e.g., 600) (e.g., a physical environment, a room, an office, and/or a building) (e.g., as described above in relation to FIGS. 8A-8B). In some embodiments, detecting the request includes detecting an input (e.g., a tap gesture, a long press gesture, a verbal request and/or command, a physical button press, a pointing input and/or air gesture, and/or a rotation of a physical input mechanism) corresponding to the request. In some embodiments, detecting the request includes receiving a message from another computer system, the message indicating that the request was received by the other computer system.

In response to (904) detecting the request to change the size of the physical window (e.g., 606a) in the physical space (e.g., 600) (e.g., as described above in relation to FIGS. 8A-8B) and in accordance with a determination that the request corresponds to a first size (e.g., a request to change the physical window to the first size and/or passthrough an amount of light as if the physical window was the first size), the computer system provides (906), via the light source (e.g., 612a-612d and/or 612), illumination in a first manner (e.g., a location, a color, an intensity, and/or a size of illumination) (e.g., as described above in relation to FIGS. 8A-8B). In some embodiments, providing the illumination in the first manner includes activating the light source and/or sending an instruction to the light source that causes the light source to provide illumination (e.g., more illumination and/or less illumination). In some embodiments, providing the illumination in the first manner includes changing light output by the light source. In some embodiments, providing the illumination in the first manner includes sending a request to the light source to modify light being output by the light source. In some embodiments, the illumination is provided in the first manner until a request is received to change or stop providing the illumination in the first manner.

In response to (904) detecting the request to change the size of the physical window in the physical space and in accordance with a determination that the request corresponds to a second size different from the first size (e.g., a request to change the physical window to the second size and/or passthrough an amount of light as if the physical window was the second size), the computer system provides (908), via the light source (e.g., 612a-612d and/or 612), illumination in a second manner different from the first manner (e.g., as described above in relation to FIGS. 8A-8B). In some embodiments, providing the illumination in the second manner includes activating the light source. In some embodiments, providing the illumination in the second manner includes changing light output by the light source. In some embodiments, providing the illumination in the second manner includes sending a request to the light source to modify light being output by the light source. In some embodiments, the illumination is provided in the second manner until a request is received to change or stop providing the illumination in the second manner. In some embodiments, providing the illumination in different manners allows the computer system to make it appear as though the amount of light coming from the window is more or less than the actual light coming from the window (e.g., more when the request corresponds to increasing the size of the window and/or less when the request corresponds to decreasing the size of the window). In some embodiments, providing illumination in a respective manner includes changing the color, intensity, brightness, tone, warmth, coolness, and/or saturation of the light source to mimic a physical environment that can be seen when looking out of the window. In some embodiments, proving illumination in a respective manner includes changing the color, intensity, brightness, tone, warmth, coolness, and/or saturation of the light source to mimic a virtual environment that is being projected as being present outside of a window. In some embodiments, the illumination is provided in a respective manner that is based on the type of environment (e.g., physical environment) on the outside of the window and/or on the outside of a structure (e.g., house, apartment, and/or building) that includes the window. Selectively providing illumination in a respective manner when a set of prescribed conditions is met automatically allows the computer system to simulate the lighting conditions of the physical space when the physical window has different sizes, thereby performing an operation when a set of conditions has been met without requiring further user input.

In some embodiments, the computer system is in communication (e.g., wireless and/or wired communication) with a first set of one or more cameras. In some embodiments, the computer system captures (e.g., before, during, and/or while detecting the request to change the size of the physical window in the physical space), via the set of one or more cameras, a first image of the physical window (e.g., 606a) (e.g., a still photo and/or a video of the physical window) (e.g., as described above in relation to FIGS. 8A-8B). In some embodiments, in response to detecting the request to change the size of the physical window in the physical space (e.g., as described above in relation to FIGS. 8A-8B) and in accordance with a determination that the request corresponds to a third size (e.g., different or the same as the first size and/or second size) and that the physical window is detected to be a fourth size using the first image, the computer system provides, via the light source (e.g., 612a-612d and/or 612), illumination in a third manner (e.g., a location, a color, an intensity, and/or a size of illumination) (e.g., the third manner is different or the same as the first manner and/or second manner) (e.g., as described above in relation to FIGS. 8A-8B). In some embodiments, in response to detecting the request to change the size of the physical window in the physical space and in accordance with a determination that the request corresponds to the third size (e.g., different or the same as the first size and/or second size) (e.g., the third size) and that the physical window is detected to be a fifth size, different from the fourth size (e.g., larger or smaller), using the first image, the computer system provides, via the light source, illumination in a fourth manner (e.g., a location, a color, an intensity, and/or a size of illumination) (e.g., the fourth manner is different or the same as the first manner and/or the second manner) different from the third manner (e.g., as described above in relation to FIGS. 8A-8B). Selectively providing illumination in a respective manner when a set of prescribed conditions are met (e.g., the physical window is detected to be a respective size) automatically allows the computer system to simulate lighting conditions in the physical space for different sized physical windows, thereby performing an operation when a set of conditions has been met without requiring further user input.

In some embodiments, the computer system is in communication (e.g., wireless communication and/or wired communication) with a second set of one or more cameras. In some embodiments, the computer system captures, via the second set of one or more cameras, a second image of the physical window (e.g., 606a) (e.g., before, during, and/or while detecting the request to change the size of the physical window in the physical space) (e.g., a still photo and/or a video of the physical window) (e.g., as described above in relation to FIGS. 8A-8B). In some embodiments, in response to detecting the request to change the size of the physical window in the physical space (e.g., as described above in relation to FIGS. 8A-8B) and in accordance with a determination that the request corresponds to a sixth size and that a first amount of illumination is passing through (e.g., visible and/or detected to be visible) the physical window using (and/or in) the second image (and/or a set of one or more images) (e.g., a first amount of illumination if entering the physical space via the physical window and/or a first amount of illumination is exiting the physical space via the physical window), the computer system provides, via the light source (e.g., 612a-612d and/or 612), illumination in a fifth manner (e.g., a location, a color, an intensity, and/or a size of illumination) (e.g., the fifth manner is different or the same as the first and/or second manner) (e.g., as described above in relation to FIGS. 8A-8B). In some embodiments, in response to detecting the request to change the size of the physical window in the physical space and in accordance with a determination that the request corresponds to the sixth size and that a second amount of illumination, different from the first amount of illumination, is passing through the physical window using the second image (e.g., a second amount of illumination is entering the physical space via the physical window and/or a second amount of illumination is exiting the physical space via the physical window), the computer system provides, via the light source, illumination in a sixth manner (e.g., a location, a color, an intensity, and/or a size of illumination) (e.g., the sixth manner is different or the same as the first and/or second manner) different from the fifth manner (e.g., as described above in relation to FIGS. 8A-8B). In some embodiments, when the illumination passing through the window is a respective amount and a request to decrease the size of the window is detected, the computer system decreases the amount of illumination provided via the light source. In some embodiments, when the illumination passing through the window is the respective amount and the request to increase the size of the window is detected, the computer system increases the amount of illumination provided via the light source. Selectively providing illumination in a respective manner when a set of prescribed conditions are met (e.g., a respective amount of illumination is detected as passing through the physical window) automatically allows the computer system to simulate the amount of light that is entering the physical space via the physical space, thereby performing an operation when a set of conditions has been met without requiring further user input.

In some embodiments, detecting the request to change the size of the physical window in the physical space includes: detecting, via the input device, an input (e.g., tap input, swipe input, voice command, and/or air hand gesture) indicating that the physical window (e.g., 606a) should be changed to a respective size (e.g., before, after, and/or while detecting the request to change the size of the physical window in the physical space) (e.g., as described above in relation to FIGS. 8A-8B). In some embodiments, in response to detecting the input indicating that the physical window should be changed to the respective size, the computer system designates (e.g., assigning, setting, and/or determining) a size of the physical window as the respective size (e.g., as described above in relation to FIGS. 8A-8B). In some embodiments, the size of the physical window corresponds to the virtual dimensions of the physical window (and, in some embodiments, not the exact size of the physical window). In some embodiments, the size of the physical window does not correspond to dimensions of the physical window. In some embodiments, the size of the window corresponds to an amount of light that passes though the physical window. In some embodiments, the size of the physical window is dependent on the time of day. In some embodiments, the size of the physical window can be changed. In some embodiments, the size of the physical window cannot be changed. Designating the size of the physical window in response to detecting the input indicating that the physical window should be changed to the respective size allows the computer system to adjust the lighting conditions within the physical space based on user preferences (e.g., based on the user defined size of the physical window), thereby providing improved visual feedback and/or reducing the number of inputs needed to perform an operation.

In some embodiments, detecting the request to change the size of the physical window (e.g., 606a) in the physical space includes detecting (e.g., before and/or while detecting the request to change the size of the physical window in the physical space) an input (e.g., tap input, swipe input, voice command, and/or air hand gesture) corresponding to a selection of a location of the physical window (e.g., a location relative to an object and/or structure within the physical space or a location relative to an object and/or structure outside of the physical space). In some embodiments, in response to detecting the input corresponding to selection of the location of the physical window (e.g., as described above in relation to FIGS. 8A-8B) and in accordance with a determination that the input corresponds to a seventh size and that the selected location of the physical window is a first location in the physical space, the computer system provides, via the light source (e.g., 612a-612d and/or 612), illumination in a seventh manner (e.g., a location, a color, an intensity, and/or a size of illumination) (e.g., the seventh manner is different or the same as the first and/or second manner) (e.g., as described above in relation to FIGS. 8A-8B). In some embodiments, in response to detecting the input corresponding to selection of the location of the physical window and in accordance with a determination that the input corresponds to the seventh size and that the selected location of the physical window is a second location, different from the first location, in the physical space, the computer system provides via the light source, illumination in an eighth manner (e.g., a location, a color, an intensity, and/or a size of illumination) (e.g., the eighth manner is different or the same as the first and/or second manner) different from the seventh manner (e.g., as described above in relation to FIGS. 8A-8B). In some embodiments, the second location overlaps the first location. In some embodiments, the first location and the second location do not overlap each other. In some embodiments, the illumination is based on the location of the window within the physical space and the time of day. In some embodiments, the computer system provides different illumination via the light source when selected locations are different because the selected location can have different illumination that is passing through a window at the location and/or different natural illumination (e.g., illumination without the light source being changed). Selectively providing illumination in a respective manner when a set of prescribed conditions is met (e.g., the selected location of the window corresponds to a respective location) automatically allows the computer system to simulate the positioning of the physical window at different location within the physical space, thereby performing an operation when a set of conditions has been met without requiring further user input.

In some embodiments, the physical window is a first physical window (e.g., 606a) (e.g., as described above in relation to FIGS. 8A-8B). In some embodiments, the physical space includes a second physical window different from the first physical window (and/or the physical window) (e.g., as described above in relation to FIGS. 8A-8B). In some embodiments, providing, via the light source (e.g., 612a-612d and/or 612), illumination in the first manner includes simulating (e.g., changing, imitating, mocking, and/or reproducing) a change in one or more characteristics of light (e.g., an increase in an amount of light, a decrease in the amount of light, an increase in the brightness of light, and/or a decrease in the brightness of light) that corresponds to the first physical window (e.g., an amount of light that is entering and/or leaving the physical space via the first physical window) without simulating a change (and/or the change) in one or more characteristics of light that corresponds to the second physical window (e.g., an amount of light that is entering and/or leaving the physical space via the second physical window and/or an amount of light that is simulated as entering and/or leaving the physical space via the second physical window) (e.g., changing illumination around and/or adjacent to the first physical window without changing illumination around and/or adjacent to the second physical window) (e.g., as described above in relation to FIGS. 8A-8B). In some embodiments, providing, via the light source, illumination in the second manner includes simulating the change in one or more characteristics of light that corresponds to the first physical window without simulating the change in one or more characteristics of light that corresponds to the second physical window. In some embodiments, the first physical window and the second physical window are on a common side and/or same side of the physical space (and, in some embodiments, are along the same wall of the physical space). In some embodiments, the first physical window and the second physical window are on opposite sides of the physical space (and/or, in some embodiments, are on different walls of the physical space). In some embodiments, the first physical window and the second physical window are identical (e.g., same size, shape, and/or transparency). In some embodiments, the first physical window and the second physical window are not identical. Simulating a change in one or more characteristics of light that corresponds to the first physical window without simulating a change in one or more characteristics of light that corresponds to the second physical window when a set of prescribed conditions is met automatically allows the computer system to selectively alter the light conditions in portions (e.g., less than the entirety of) of the physical space while not altering lighting conditions in other portions of the physical space, thereby performing an operation when a set of conditions has been met without requiring further user input.

In some embodiments, the physical window is a third physical window (e.g., 606a) (e.g., as described above in relation to FIGS. 8A-8B). In some embodiments, the physical space includes a fourth physical window (e.g., as described above in relation to FIGS. 8A-8B). In some embodiments, providing, via the light source (e.g., 612a-612d and/or 612), illumination in the first manner includes simulating a change in one or more characteristics of light (e.g., an increase in an amount of light, a decrease in the amount of light, an increase in the brightness of light, and/or a decrease in the brightness of light) that corresponds to the third physical window and simulating a change in one or more characteristics of light that corresponds to the fourth physical window (e.g., as described above in relation to FIGS. 8A-8B) (e.g., an amount of light that is entering and/or leaving the physical space via the third physical window and the fourth physical space and/or an amount of light that is simulated as entering and/or leaving the physical space via the third physical window and the fourth physical window). In some embodiments, providing, via the light source, illumination in the second manner includes simulating the change in the one or more characteristics of light that corresponds to the third physical window and simulating the change in the one or more characteristics of light that corresponds to the fourth physical window. In some embodiments, the simulated change in the one or more characteristics of the light that corresponds to the third physical window includes changing one or more light sources in a different manner than the manner used to change one or more light sources to simulate the change of the one or more characteristics of the light that corresponds to the fourth physical window. In some embodiments, the simulated change in the one or more characteristics of the light that corresponds to the third physical window includes changing one or more light sources in the same manner as the manner used to change one or more light sources to simulate the change of the one or more characteristics of the light that corresponds to the fourth physical window. In some embodiments, the third physical window and the fourth physical window are on a common side and/or same side of the physical space (and, in some embodiments, are along the same wall of the physical space). In some embodiments, the third physical window and the fourth physical window are on opposite sides of the physical space (and/or, in some embodiments, are on different walls of the physical space). In some embodiments, the third physical window and the fourth physical window are identical (e.g., same size, shape, and/or transparency). In some embodiments, the third physical window and the fourth physical window are not identical. Simulating a change in one or more characteristics of light that corresponds to the third physical window and the fourth physical window when a set of prescribed conditions is met automatically allows the computer system to simultaneously alter lighting conditions in two or more discrete portions of the physical space, thereby performing an operation when a set of conditions has been met without requiring further user input.

In some embodiments, providing, via the light source (e.g., 612a-612d and/or 612), illumination in the first manner and the second manner is based on (e.g., according to, pertaining to, stemming from, dependent upon) a current location of the computer system within the physical space (e.g., as described above in relation to FIGS. 8A-8B). In some embodiments, the closer the computer system is to the physical window, the more light the light source provides. In some embodiments, the further the computer system is from the physical window, the less the light source provides. In some embodiments, providing illumination in the first manner and the second manner is not based on the current location of the computer system within the physical space. In some embodiments, one or more characteristics of the illumination change as the computer system moves throughout the physical space. Providing illumination based on the current location of the computer system within the physical space when a set of prescribed conditions is met automatically allows the computer system to dynamically change the illumination of physical space as the computer system moves throughout the physical space, thereby performing an operation when a set of conditions has been met without requiring further user input.

In some embodiments, the illumination provided in the first manner (and, in some embodiments the second manner) via the light source (e.g., 612a-612d and/or 612) is based on (e.g., according to, pertaining to, stemming from, dependent upon) a location (e.g., a location of an external computer system that the computer system is in communication with (and, in some embodiments, the owner and/or user of the external computer system is different from the owner/user of the computer system) (e.g., in communication with via a live communication session, such as a telephone call, a video call, and/or a messaging session), a previous location of the computer system, a present location of the computer system, and/or a future location of the computer system) that is more than a threshold distance (e.g., 10-100,000 miles) away from the current location of the computer system (e.g., as described above in relation to FIGS. 8A-8B). Providing illumination based on a location that is away from the location of the computer system when a set of prescribed conditions is met automatically allows the computer system to provide an indication of the current lighting conditions in various environments from around the world, thereby performing an operation when a set of conditions has been met without requiring further user input.

In some embodiments, providing illumination in the first manner includes outputting, via the light source (e.g., 612a-612d and/or 612), a first amount of light (e.g., 0.5 lux, 1 lux, 2 lux, 5 lux, or 10 lux). In some embodiments, providing illumination in the second manner includes outputting, via the light source, a second amount of light (e.g., 0.5 lux, 1 lux, 2 lux, 5 lux, or 10 lux) different from (e.g., 0.5×, 1.5×, 2×, 5×, or 10× more or less light) the first amount of light (e.g., as described above in relation to FIGS. 8A-8B). In some embodiments, providing illumination in the first manner and the second manner includes outputting the same amount of light. In some embodiments, the first amount of light is a factor and/or multiple of the second amount of light. In some embodiments, providing illumination in the first manner includes causing a first number of light sources to provide light and/or change an amount of light being provided by the first number of light sources, and providing illumination in the second manner includes causing a second number, different from the first number, of light sources to provide light and/or change an amount of light being provided by the second number of light sources. Selectively providing a different amount of illumination when a set of prescribed conditions is met automatically allows the computer system to vary the amount of light within the physical space based on a selected size of the physical window, thereby performing an operation when a set of conditions has been met without requiring further user input.

In some embodiments, providing illumination in the first manner (and/or the second manner) includes simulating (e.g., imitating, mimicking, and/or mocking) light as passing through (e.g., emanating from, spreading from) the physical window (e.g., 606a) (e.g., light is simulated as entering and/or exiting the physical space via the first physical space) from an area outside of (and/or external to and/or not internal to) the physical space (e.g., an area external to the physical space and/or on the opposite side of the window from the physical space) to an area within (and/or internal to and/or not external to) the physical space (and/or on the same side of window) (e.g., as described above in relation to FIGS. 8A-8B). In some embodiments, providing illumination in the first manner and the second manner includes simulating light as passing through the physical window from an area within the physical space to an area outside of the physical space. Simulating light as passing through the physical window from an area outside of the physical space when a set of prescribed conditions is met automatically allows the computer system to simulate lighting conditions in an area that is directly outside of the physical space, thereby performing an operation when a set of conditions has been met without requiring further user input.

In some embodiments, the request to change the size of the physical window (e.g., 606a) in the physical space (e.g., 600) is a request decrease the size of the physical window (e.g., decrease by 2×, 3×, 4×, 5× or 10×). In some embodiments, providing, via the light source (e.g., 612a-612d and/or 612), illumination in the first manner (and/or second manner) includes decreasing the illumination in the physical space (and, in some embodiments, simulating (e.g., imitating, mimicking, and/or mocking) a decrease in the amount of light that corresponds to (e.g., light that is simulated as entering and/or exiting the physical space via the physical window) the physical window) (e.g., as described above in relation to FIGS. 8A-8B). In some embodiments, the size of the physical window does not change in response to receiving the request to decrease the size of the physical window. In some embodiments, the light source simulates the same decrease in the amount of light that corresponds to the physical window while providing illumination in the first manner and the second manner. In some embodiments, the light source simulates a different amount in the decrease amount of light that corresponds to the physical window while providing illumination in the first manner in contrast to when the light source provides illumination in the second manner. Decreasing the illumination in the physical space in response to detecting the request to decrease the size of the physical window allows the computer system to simulate the lighting conditions within the physical space if the physical window was of a smaller size, thereby performing an operation when a set of conditions has been met without requiring further user input.

In some embodiments, the request to change the size of the physical window (e.g., 606a) in the physical space (e.g., 600) is a request to increase the size of the physical window (e.g., decrease by 2×, 3×, 4×, 5× or 10×). In some embodiments, providing, via the light source (e.g., 612a-612d and/or 612), illumination in the first manner (and/or second manner) includes increasing the illumination in the physical space (and/or simulating an increase in the amount of light that corresponds to (e.g., light that is simulated as entering and/or exiting the physical space via the physical window) the physical window) (e.g., as described above in relation to FIGS. 8A-8B). In some embodiments, the size of the physical window does not change in response to receiving the request to increase the size of the physical window. In some embodiments, the light source simulates the same increase in the amount of light that corresponds to the physical window while providing illumination in the first manner and the second manner. In some embodiments, the light source simulates a different amount of increase in the amount of light that corresponds to the physical window while providing illumination in the first manner in contrast to when the light source provides illumination in the second manner. Increasing the illumination in the physical space in response to detecting the request to increase the size of the physical window allows the computer system to simulate the lighting conditions within the physical space if the physical window was of a larger size, thereby performing an operation when a set of conditions has been met without requiring further user input.

In some embodiments, in response to detecting the request to change the size of the physical window (e.g., 606a) in the physical space (e.g., 600) and in accordance with a determination that the request corresponds to an eighth size that is less than a threshold size (e.g., above 1-10 square feet or 1-120 square inches), the computer system forgoes providing, via the light source (e.g., 612a-612d and/or 612), illumination (and/or decreasing the illumination provided to a zero amount and/or an amount not greater than a threshold amount (e.g., 0.1-1 lux) and/or not increasing the illumination provided above a zero amount and/or an amount greater than the threshold amount) (e.g., as described above in relation to FIGS. 8A-8B). In some embodiments, the physical space is not illuminated when the light source does not provide illumination and/or change the illumination. In some embodiments, the physical space is illuminated when the light source does not provide illumination and/or change the illumination. In some embodiments, the size threshold is determined by a user. In some embodiments, the size threshold is determined by the computer system. In some embodiments, the size threshold is determined based on the size of the physical space (e.g., when the physical space is bigger, the threshold is bigger). In some embodiments, the size threshold is determined based on the actual size of the first physical window. In some embodiments, the size threshold is determined based on the shape of the physical space and/or one or more objects in the physical space (e.g., one or more objects close to, in front of, adjacent to, and/or near the physical window). Forgoing providing illumination in the physical space when a set of prescribed conditions is met (e.g., the request to change the size of the physical window corresponds to a size that is less than threshold size) automatically allows the computer system to simulate lighting conditions within the physical space if light were not able to passthrough the physical window, thereby performing an operation when a set of conditions has been met without requiring further user input.

In some embodiments, the threshold size corresponds to (e.g., is and/or is set as) a size greater than zero (e.g., as described above in relation to FIGS. 8A-8B).

In some embodiments, the threshold size corresponds to (e.g., is and/or is set as) a size of zero (e.g., as described above in relation to FIGS. 8A-8B).

In some embodiments, providing, via the light source (e.g., 612a-612d and/or 612), illumination in the first manner includes: during a first period of time while providing the illumination in the first manner, changing, via the light source, the illumination by a first illumination amount (e.g., as described above in relation to FIGS. 8A-8B); and during a second period of time, different from the first period of time, while providing the illumination in the first manner, changing, via the light source, the illumination by a second illumination amount different from the first illumination amount (e.g., as described above in relation to FIGS. 8A-8B). In some embodiments, while providing, via the light source, illumination in the first manner, the computer system detects the expiration of a period of time (e.g., 1-600 seconds). In some embodiments, in response to detecting the expiration of the period of time and without detecting an input (e.g., without intervening input, automatically), the computer system: ceases providing illumination in the first manner; and provides, via the light source, illumination in a fifth manner (e.g., a location, a color, an intensity, and/or a size of illumination) different (e.g., the light source outputs more or less illumination while outputting illumination in the fifth manner than the when the light source outputs illumination in the first manner) from the first manner. In some embodiments, the light source ceases to provide illumination in the fifth manner and provides illumination in the first manner in response to the detection of the expiration of a respective period of time. Changing the illumination by a first illumination amount during a first period of time and changing the illumination by a second amount during a second time period automatically allows the computer system to vary the amount of illumination in the physical space to simulate how the characteristics of light change as time passes, thereby performing an operation when a set of conditions has been met without requiring further user input.

In some embodiments, while providing, via the light source (e.g., 612a-612d and/or 612), illumination in the first manner, the computer system detects, via the input device, an input (e.g., swipe input, tap input, long press, voice command, gaze, and/or hand air gesture) corresponding to an additional request to change the size of the physical window (e.g., as described above in relation to FIGS. 8A-8B). In some embodiments, in response to detecting the input corresponding to the additional request to change the size of the physical window, the computer system ceases providing illumination in the first manner and the computer system provides, via the light source, illumination in a fifth manner (e.g., a location, a color, an intensity, and/or a size of illumination) different from (e.g., the light source outputs more or less illumination while outputting illumination in the fifth manner than the when the light source outputs illumination in the first manner) the first manner (e.g., as described above in relation to FIGS. 8A-8B). In some embodiments, the computer system, via the light source, ceases to provide illumination in the fifth manner and provides illumination in the first manner in response to the detection of the same or different respective input. In some embodiments, the fifth manner is based on the additional request and not the original request and the first manner is not based on the additional request (e.g., size of the physical window indicated by and/or that corresponds to the additional request). Ceasing to provide illumination in the first manner and providing illumination in the fifth manner in response to detecting the input corresponding to the additional request to change the size of the window allows the computer system to provide an indication of the state of the computer system (e.g., that the computer system has detected the input corresponding to the additional request to change the size of the window), thereby providing improved feedback.

In some embodiments, providing, via the light source (e.g., 612a-612d and/or 612), illumination in the first manner includes causing a first silhouette (e.g., a shape and/or outline that is formed by the absence of light (e.g., a shadow)) to appear in the physical space. In some embodiments, providing, via the light source, illumination in the second manner includes causing a second silhouette (e.g., a shape and/or outline that is formed by the absence of light (e.g., a shadow)), different from (e.g., different in size, shape, tone, color, warmth, coolness, and/or brightness) the first silhouette, to appear in the physical space (e.g., as described above in relation to FIGS. 8A-8B). Causing a first silhouette to appear in the physical space when a set of prescribed conditions is met automatically allows the computer system to simulate the appearance of one or more objects (e.g., one or more objects in the physical space or one or more objects in a space that is external to the physical space), thereby performing an operation when a set of conditions has been met without requiring further user input.

In some embodiments, the light source (e.g., 612a-612d and/or 612) includes a first external light and a second external light different from the first external light. In some embodiments, providing, via the light source, illumination in the first manner includes causing the first external light (e.g., 612a-612d) (e.g., an illumination device, a point light source, a spotlight, and/or one or more light sources) to provide first illumination (e.g., as described above in relation to FIGS. 8A-8B); and causing the second external light (e.g., 612a-612d) (e.g., an illumination device, a point light source, a spotlight, and/or one or more light sources) to provide second illumination (e.g., separate from and/or different from the first illumination) (e.g., as described above in relation to FIGS. 8A-8B). In some embodiments, the first illumination is a different amount, different shape, different color, different tone, and/or different brightness than the second illumination. In some embodiments, the first external light and the second external light are the same types of lights. In some embodiments, the first external light and the second external light are different types of light (e.g., a ceiling light, a floor light, a light bulb, an LED light, a halogen light, a light that is fixed and/or attached to the physical space, and/or a light that is not attached and/or fixed the physical space). In some embodiments, the first illumination is the same amount, same shape, same color, same tone, and/or same brightness as the second illumination. Causing the first external light to provide first illumination and causing the second external light to provide illumination when a set of prescribed conditions is met allows the computer system to illuminate the physical space using multiple lights, thereby performing an operation when a set of conditions has been met without requiring further user input.

Note that details of the processes described above with respect to method 900 (e.g., FIG. 9) are also applicable in an analogous manner to other methods described herein. For example, method 700 optionally includes one or more of the characteristics of the various methods described herein. For example, a physical space can be illuminated using one or more techniques described herein in relation to method 900, where the illumination of the physical space is initiated based on the detection of a respective color of light within the physical space as described herein in relation to method 1100. For brevity, these details are not repeated herein.

FIGS. 10A-10B illustrate techniques for adjusting one or more lighting conditions in accordance with some embodiments. Such figures are used to illustrate the processes described below, including the processes in FIG. 11.

FIGS. 10A-10B illustrate physical space 600. It should be recognized that one or more aspects discussed above with respect to physical space 600 in the discussion of FIGS. 6A-6B and 8A-8B are applicable to physical space 600 in FIGS. 10A-10B, including ceiling 602, light sources 612, middle wall 606, window 606a, clock 606b, and desk 618. In the discussion of FIGS. 10A-10B below, it is described that a controller device (e.g., a smart phone, a watch, a tablet, a fitness tracking device, a wearable device, a television, a multi-media device, an accessory, a head-mounted device (HMD) and/or a personal computing device) and/or computer system detects a color of light within physical space 600 and causes light sources 612 to perform an operation. Light sources 612 include light sources 612a-612d, which are used to illuminate physical space 600. However, it should be recognized that one or more one computer systems and/or controller devices can detect sensor data, communicate the sensor data, determine an operation to perform in response to the sensor data, and/or cause an operation to be performed. For example, in some embodiments, light source 612a detects a color of light in physical space 600, determines that the color of light satisfies a set of one or more criteria and, in response, changes a color of light being emitted by light source 612a and/or light source 612b. As another example, a personal device (e.g., a smart phone, a watch, a tablet, a fitness tracking device, a wearable device, a television, a multi-media device, an accessory, a head-mounted device (HMD) and/or a personal computing device) of a user can receive an image of physical space 600 from a camera external to the personal device, detect a color of light in physical space 600 via the image, determine that the color of light satisfies a set of one or more criteria, and in response, change a color of light being emitted by light source 612a and/or light source 612b. Please note that the example of light source 612a and light source 612b is merely an example, and light source 612c and light source 612d are also capable of performing the abovementioned operations.

As illustrated in FIG. 10A, clock 606b displays that the current time is 3:00 PM. Additionally, window 606a is filled with diagonal hashing to indicate a color of light (e.g., blue, red, yellow, orange, and/or green) that is entering physical space 600 via window 606a. In some embodiments, a color of light can be a solid color, a pattern of light, and/or a gradient. In some embodiments, light passed through window 606a impacts the ambient lighting within physical space 600.

In some embodiments, other sources of light can impact the ambient lighting within physical space 600. For example, an object (e.g., a lamp, a flashlight, a display screen, a computer system, and/or a candle) within physical space 600 can emit light that changes a color of the ambient lighting within physical space 600. In some embodiments, the color of the light entering physical space 600 and being passed through window 606a in FIG. 10A does not cause the color of light within physical space 600 to satisfy a set of one or more criteria for changing the color of light within physical space 600.

As illustrated in FIG. 10A, light sources 612 emit light into physical space 600 (e.g., as represented by the diagonal hatching that fills each light source within light sources 612). Prior to FIG. 10A, a computer system has determined (e.g., chosen and/or selected) that light sources 612 should emit white light into physical space 600. In some embodiments, a color of such light is defined by a user and/or a computer system when initiating output of the light. For example, a user can request that light sources 612 emit blue light or light that matches an amount of light and/or color of light at another different time of day (e.g., causing illumination to change across the day).

As illustrated in FIG. 10B, clock 606b displays that the current time is 3:30 PM. Accordingly, thirty minutes have elapsed between FIG. 10A and FIG. 10B. As illustrated in FIG. 10B, window 606a is filled with horizontal hashing, indicating that the light on the exterior of physical space 600 is an orange color (e.g., the color of the light in the environment exterior to window 606a changes between FIGS. 10A and 10B) (and/or a different color than the color in FIG. 10A). At FIG. 10B, an orange-colored light is entering physical space 600 via window 606a, and the ambient lighting within physical space 600 has an orange hue.

At FIG. 10B, a determination is made (e.g., by a controller device, light sources 612 and/or by a computer system that is external to light sources 612) that the orange color of light is entering physical environment 600 (e.g., the white light emitted by light sources 612 is overpowered by the orange incoming light, leading to the ambient lighting of physical space 600 to become orange) (e.g., the controller device detected the color of the incoming light while light sources 612 were illuminating physical space 600).

In some embodiments, the controller device detects incoming light when light sources 612 are not illuminating physical space 600. For example, in a scenario where light sources 612 are not emitting light (e.g., are in an inactive and/or sleep mode), light sources 612 offset the incoming light because a determination is made that the color of incoming light from window 606a satisfies a set of one or more criteria. In some embodiments, in a scenario where light sources 612 are not emitting light (e.g., are in an inactive and/or sleep mode), in response to detecting that the color of incoming light from window 606a satisfies a set of one or more criteria, light sources 612 do not offset the incoming light. In some embodiments, light sources 612 only offset incoming light if a user is detected in physical space 600.

In some embodiments, a determination is made that the color of light entering physical space 600 satisfies the set of one or more criteria for changing the color of light within physical space 600. In some embodiments, the determination is made using an image of physical space 600 (e.g., of a general or specific area, such as an image of window 606a or wall 606). In other embodiments, the determination is made using an indication received from a server (e.g., a weather service). In other embodiments, the determination is made based on input, such as a verbal input indicating that the color of light in a room has an orange hue. In some embodiments, a determination is made (e.g., by light sources 612 and/or by a computer system that is external to light sources 612) that the orange hue within physical space 600 satisfies a set of one or more criteria intensity.

At FIG. 10B, based on the determination that the orange color of light is entering physical space 600, light sources 612 begin to emit light with a blue color to offset the orange light. That is, based on a determination that a respective color of light is entering physical space 600 or that a respective color of light is presently within physical space 600, light sources 612 emit a color of light that neutralizes the respective color of light within physical space 600. At FIG. 10B, because light sources 612 are emitting blue light, light sources 612 are filled with horizontal hatching (e.g., that is representative of the blue light) (e.g., in contrast with the horizontal hatching that fills light sources 612 at FIG. 10A. At FIG. 10B, in response to determining that blue light is required, light sources 612 emit blue light into physical space 600 (e.g., as evidenced by vertical hatching on light sources 612 contrasted with horizontal hatching on window 606a). In some embodiments, the controller device determines that blue light is required to offset the orange light. In some embodiments, the controller device determines that a color other than blue is required to offset the orange light.

In some embodiments, light sources 612 do not emit a color of light that offsets a respective color of light that is detected within physical space 600. For example, light sources 612 emit colorless light and/or no light. In some embodiments, light sources 612 offset and/or do not offset a detected color of light within physical space 600 based on a user preference (e.g., a user prefers yellow light), a current state of light sources 612, and/or an active setting of light sources 612.

In some embodiments, based on the detection of a respective color of light within physical space 600, light sources 612 increase or decrease the amount of illumination within physical space 600. For example, based on a determination that a color of light with a dark tone (e.g., black and/or grey) (e.g., color that decreases the overall brightness of physical space 600) is present within physical space 600, light sources 612 will increase the amount of illumination emitted. In some embodiments, to the contrary, based on a determination that a color of light with a bright tone (e.g., yellow and/or pink) (e.g., a color that increases the overall brightness of physical space 600) is present within physical space 600, light sources 612 will decrease the amount of illumination emitted.

In some embodiments, light sources 612 emit a different color of light based on a determination that the color of light within physical space 600 is changing and/or has changed For example, based on a determination being made that the light within physical space 600 changes from an orange color (e.g., as described above) to a green color, light sources 612 transition from emitting blue light (e.g., as described above) to emitting red light.

In some embodiments, light sources 612 change one or more characteristics of illumination over a period of time. In some embodiments, in the time between FIGS. 10A and 10B, (e.g., a time passage of thirty minutes), at FIG. 10A, light sources 612 emit one type of light (e.g., light sources 612 do not offset any incoming light into physical space 600). At FIG. 10B, thirty minutes have passed (e.g., the sun has changed position), and light sources 612 (and/or a computer system that is external to light sources 612) detect an orange color of light in physical space 600. In response, light sources 612 determine that the color of light satisfies a set of one or more criteria, and based on the determination, change a color of light emit by light sources 612 to offset the incoming orange light. As another example, in the late afternoon, light sources 612 (and/or a computer system that is external to light sources 612) detect a light blue color of light in physical space 600. In response to detecting a color of incoming light, light sources 612 emit one type of light (e.g., light sources 612 do not offset any incoming light into physical space 600). Accordingly, when an hour passes from late afternoon to nighttime, light sources 612 (and/or a computer system that is external to light sources 612) detect a dark blue color of light in physical space 600. In response, light sources 612 determine that the dark blue color of light satisfies a set of one or more criteria, and based on the determination, change a color of light and level of brightness emit by light sources 612 to offset the incoming dark blue light.

FIG. 11 is a flow diagram illustrating a method (e.g., method 1100) for adjusting one or more lighting conditions in accordance with some embodiments. Some operations in method 1100 are, optionally, combined, the orders of some operations are, optionally, changed, and some operations are, optionally, omitted.

As described below, method 1100 provides an intuitive way for adjusting one or more lighting conditions. Method 1100 reduces the cognitive burden on a user, thereby creating a more efficient human-machine interface. For battery-operated computing devices, enabling a user to interact with such devices faster and more efficiently conserves power and increases the time between battery charges.

In some embodiments, method 1100 is performed at a computer system that is in communication with an external light source (e.g., 612a-612d and/or 612) (e.g., an illumination device, a point light source, a spotlight, and/or one or more light sources) and an input device (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device. In some embodiments, the light source is not physically connected to and/or coupled to the computer system.

The computer system detects (1102), via the input device, that a physical environment (and/or a physical space as described above in relation to method 900) includes a respective color of light (e.g., as described above in relation to FIGS. 10A-10B). In some embodiments, detecting that the physical environment includes the respective color of light includes capturing, via a camera, an image of the physical environment. In some embodiments, detecting that the physical environment includes the respective color of light includes receiving a message from another computer system, the message including an indication of the respective color.

In response to (1104) detecting that the physical environment includes the respective color of light and in accordance with a determination that the respective color is a first color, the computer system provides (1106), via the external light source (e.g., 612a-612d and/or 612), illumination in a first manner (e.g., a location, a color, an intensity, and/or a size of illumination) (e.g., as described above in relation to FIGS. 10A-10B). In some embodiments, providing the illumination in the first manner includes activating the light source. In some embodiments, providing the illumination in the first manner includes changing light output by the light source. In some embodiments, providing the illumination in the first manner includes sending a request to the light source to modify light being output by the light source. In some embodiments, the illumination is provided in the first manner until a request is received to change or stop providing the illumination in the first manner.

In response to (1104) detecting that the physical environment includes the respective color of light and in accordance with a determination that the respective color is a second color different from the first color, the computer system provides (1108), via the external light source (e.g., 612a-612d and/or 612), illumination in a second manner (e.g., without, in some embodiments, providing illumination in the first manner) different from the first manner (e.g., as described above in relation to FIGS. 10A-10B). In some embodiments, the difference in providing illumination in the first manner and the second manner does not include changing only the color of illumination from one color to different colors. In some embodiments, the difference in providing illumination in the first manner and the second manner does not include changing the color of the illumination. Selectively providing illumination based on a respective color of light of a physical environment automatically allows the computer system to mitigate any impacts the respective color of light of the physical environment may have on the senses of an individual, thereby performing an operation when a set of conditions has been met without requiring further user input.

In some embodiments, providing illumination in the first manner includes increasing, via the external light source (e.g., 612a-612d and/or 612), a first amount of illumination (e.g., light and/or brightness) within the physical environment (e.g., 600) (e.g., as described above in relation to FIGS. 10A-10B). In some embodiments, providing illumination in the second manner includes increasing, via the external light source, an amount of illumination (e.g., and/or brightness) within the physical environment. In some embodiments, the illumination increases by a greater amount or smaller amount when the illumination is provided in the first manner versus when the illumination is provided is the second manner. In some embodiments, the illumination increases by the same amount when the illumination is provided in the first manner in comparison to when the illumination is provided in the second manner. In some embodiments, the illumination increases at a faster rate or slower rate when the illumination is provided in the first manner versus when the illumination is provided in the second manner. In some embodiments, the illumination increases at the same rate when the illumination is provided in the first manner in comparison to when illumination is provided in the second manner. Increasing the first amount of illumination within the physical environment when a set of prescribed conditions is met automatically allows the computer to offset any decreases to the amount of illumination in the physical environment caused by the color of light within the physical environment, thereby performing an operation when a set of conditions has been met without requiring further user input.

In some embodiments, providing illumination in the first manner includes decreasing, via the external light source (e.g., 612a-612d and/or 612), a second amount of illumination (e.g., and/or brightness) within the physical environment (e.g., 600) (e.g., as described above in relation to FIGS. 10A-10B). In some embodiments, providing illumination in the second manner includes decreasing, via the external light source, an amount of illumination (e.g., and/or brightness) of physical environment. In some embodiments, the illumination decreases by a greater amount or a smaller amount when the illumination is provided in the first manner versus when the illumination is provided in the second manner. In some embodiments, the illumination decreases by the same amount when the illumination is provided in the first manner or the second manner. In some embodiments, the illumination decreases at a faster rate or slower rate when the illumination is provided in the first manner in comparison to when the illumination is provided is the second manner. In some embodiments, the illumination decreases at the same rate when the illumination is provided in the first manner or the second manner. Decreasing the second amount of illumination within the physical environment when a set of prescribed conditions is met automatically allows the computer to offset any increases to the amount of illumination in the physical environment caused by the color of light within the physical environment, thereby performing an operation when a set of conditions has been met without requiring further user input.

In some embodiments, providing illumination in the first manner includes outputting, via the external light source (e.g., 612a-612d), a third color (orange, blue, red, green, and/or yellow). In some embodiments, providing illumination in the second manner includes outputting, via the external light source, a fourth color different from the third color (e.g., as described above in relation to FIGS. 10A-10B). In some embodiments, the third color is different from the first color. In some embodiments, the fourth color is different from the second color. In some embodiments, the third color and/or the fourth color is a combination of two or more colors. In some embodiments, the third color and/or the fourth color neutralizes the respective color (e.g., to white, to black, to be less warm, and/or to be less cool). In some embodiments, the third color and/or the fourth color are opposite (e.g., opposite the respective color on the color wheel) of the respective color and/or each other. Outputting a respective color when a set of prescribed conditions is met automatically allows the computer system to selectively output a color that complements or contrasts with the respective color of light that is detected in the physical environment such that the effects of the respective color of light are enhanced or mitigated, thereby performing an operation when a set of conditions has been met without requiring further user input.

In some embodiments, providing illumination in the first manner includes outputting, via the external light source, a color that neutralizes (e.g., offsets, counterbalances, counteracts effects of, and/or nullifies) the respective color (e.g., as described above in relation to FIGS. 10A-10B). In some embodiments, providing illumination in the second manner includes outputting, via the external light source, a color that does not neutralize the respective color. In some embodiments, providing illumination in the second manner includes outputting, via the external light source, a color that neutralizes the respective color. In some embodiments, the respective color is not visible while the external light source outputs the color that neutralizes the respective color. In some embodiments, neither the respective color nor the color that neutralizes the respective color are visible (and/or appears to be visible) while the external light source outputs the color that neutralizes the respective color. In some embodiments, the color that neutralizes the respective color is not visible while the respective color is detected in the environment. In some embodiments, another color different from the respective color and the color that neutralizes the respective color is visible while the computer system outputs the color that neutralizes the respective color. Outputting a color that neutralizes the respective color when a set of prescribed conditions is met automatically allows the computer system to mitigate any effects the respective color may have on the senses of individuals in the physical environment, thereby performing an operation when a set of conditions has been met without requiring further user input.

In some embodiments, while (e.g., and/or before) detecting that the physical environment (e.g., 600) includes the respective color of light, the computer system provides, via the external light source (e.g., 612a-612d), illumination in a third manner (e.g., a location, a color, an intensity, and/or a size of illumination) (e.g., the third manner is different than the first and/or second manner) (e.g., as described above in relation to FIGS. 10A-10B). In some embodiments, in response to detecting that the physical environment includes the respective color of light and in accordance with a determination that the respective color is a fifth color (e.g., red, blue, yellow, orange and/or black) different from the first color and the second color, the computer system continues to provide, via the external light source, illumination in the third manner (e.g., as described above in relation to FIGS. 10A-10B). In some embodiments, the fifth color is a shade of the first and/or second color. In some embodiments, in response to detecting that the physical environment includes the respective color of light and in accordance with a determination that the respective color is the fifth color the, the computer system provides illumination in the first manner and/or the second manner. Continuing to provide illumination in the third manner when a set of prescribed conditions is met automatically allows the computer system to not cause disruption to the ambiance that is created in the physical environment as a result of the physical environment including the fifth color, thereby performing an operation when a set of conditions has been met without requiring further user input.

In some embodiments, the respective color of light is a first respective color of light (e.g., red, yellow, blue, orange, and/or green) (e.g., before detecting that the respective color of light changes from the first respective color of light to another respective color of light). In some embodiments, while providing, via the external light source (e.g., 612a-612d), illumination in the first manner (and/or in the second manner), the computer system detects, via the input device, that the respective color of light changes from the first respective color of light to a second respective color of light (e.g., the first respective color of light changes based on environmental changes and/or based on a change to the operation state of an artificial light) (e.g., as described above in relation to FIGS. 10A-10B). In some embodiments, in response to detecting that the respective color of light changes from the first respective color of light to the second respective color of light (e.g., while providing, via the external light source, illumination in the first manner), the computer system provides, via the external light source, illumination in a fourth manner different (e.g., different color, different intensity of color, different tone of color, different hue of color) from the first manner (e.g., and/or the second manner) (e.g., as described above in relation to FIGS. 10A-10B). In some embodiments, in response to detecting that the respective color of light changes from the first respective color of light to the second respective color of light, the computer system continues to provide illumination in the first manner. In some embodiments, the external light source outputs a different color of light while the external light source outputs illumination in the fourth manner in contrast to when the external light source outputs illumination in the first manner. In some embodiments, the external light source outputs the same color of light while the external light source outputs illumination in the fourth manner in contrast to when the external light source outputs illumination in the first manner. Providing illumination in the fourth manner different from the first manner in response to detecting that the respective color of light changes from the first respective color of light to the second respective color of light allows the computer system to continually update the illumination in the physical space based on detected changes to the color of light in the physical environment, thereby providing improved feedback to the user and/or reducing the number of inputs needed to perform an operation.

In some embodiments, providing, via the external light source (e.g., 612a-612d), illumination in the first manner includes outputting a color of light (e.g., orange, yellow, green, blue, and/or red) that is different than the respective color of light (e.g., as described above in relation to FIGS. 10A-10B). In some embodiments, providing illumination in the first manner includes outputting a color of light that is a shade of the respective color of light. In some embodiments, providing, via the external light source, illumination in the second manner includes outputting another color that is different from the respective color of light. Outputting a color of light that is different from the respective color of light when a set of prescribed conditions is met automatically allows the computer system to output a color that complements or contrasts with the respective color of light that is detected in the physical environment such that the effects of the color of light are enhanced or mitigated, thereby performing an operation when a set of conditions has been met without requiring further user input.

In some embodiments, the external light source (e.g., 612a-612d) includes a first external light (e.g., 612a-612d) and a second external light (e.g., 612a-612d) different from the first external light. In some embodiments, providing, via the light source, illumination in the first manner includes: causing the first external light (e.g., an illumination device, a point light source, a spotlight, and/or one or more light sources) to provide first illumination (e.g., as described above in relation to FIGS. 10A-10B); and causing the second external light (e.g., an illumination device, a point light source, a spotlight, and/or one or more light sources) to provide second illumination (e.g., separate from and/or different from the first illumination) (e.g., as described above in relation to FIGS. 10A-10B). In some embodiments, the first illumination is a different amount, different shape, different color, different tone, and/or different brightness than the second illumination. In some embodiments, the first external light and the second external light are the same types of lights. In some embodiments, the first external light and the second external light are different types of light (e.g., a ceiling light, a floor light, a light bulb, an LED light, a halogen light, a light that is fixed and/or attached to the physical space, and/or a light that is not attached and/or fixed the physical space). In some embodiments, the first illumination is the same amount, same shape, same color, same tone, and/or same brightness as the second illumination. Causing the first external light to provide illumination and causing the second external light to provide second illumination when a set of prescribed conditions is met automatically allows the computer system to simultaneously offset the effects of the respective color in different portions of the physical environment, thereby performing an operation when a set of conditions has been met without requiring further user input.

In some embodiments, providing, via the external light source, illumination in the first manner includes: during a first period of time while providing the illumination in the first manner, changing, via the light source (e.g., 612a-612d), the illumination by a first illumination amount (e.g., as described above in relation to FIGS. 10A-10B) and during a second period of time, different from the first period of time, while providing the illumination in the first manner, changing, via the light source (e.g., 612a-612d), the illumination by a second illumination amount different from the first illumination amount (e.g., as described above in relation to FIGS. 10A-10B). In some embodiments, while providing, via the light source, illumination in the first manner, the computer system detects the expiration of a period of time (e.g., 1-600 seconds). In some embodiments, in response to detecting the expiration of the period of time and without detecting an input (e.g., without intervening input and/or automatically), the computer system: ceases providing illumination in the first manner and provides, via the light source, illumination in a fifth manner (e.g., a location, a color, an intensity, and/or a size of illumination) different (e.g., the light source outputs more or less illumination while outputting illumination in the fifth manner than the when the light source outputs illumination in the fifth manner) from the first manner. In some embodiments, the light source ceases to provide illumination in the fifth manner and provides illumination in the first manner in response to the detection of the expiration of a respective period of time. Changing the illumination by a first illumination amount during a first period of time and changing the illumination by a second illumination amount during a second period of time when a set of prescribed conditions is met automatically allows the computer system to change the ambiance and/or illumination within a physical space over different periods of time to account for any changes to one or more conditions of the physical space, thereby performing an operation when a set of conditions has been met without requiring further user input.

In some embodiments, providing, via the external light source, illumination in the first manner includes: in accordance with a determination that a detected user preference (e.g., a setting, a preference determined by one or more historical preferences and/or actions of the user, and/or a learned preference over time) is a first user preference, causing the external light source (e.g., 612a-612d) to illuminate light with a first characteristic (e.g., amount of color, light, brightness, and/or shape) and not a second characteristic (e.g., as described above in relation to FIGS. 10A-10B) and in accordance with a determination that the detected user preference (e.g., a setting, a preference determined by one or more historical preferences and/or actions of the user, and/or a learned preference over time) is a second user preference different from the first user preference, causing the external lights source (e.g., 612a-612d) to illuminate light with the second characteristic and not the first characteristic (e.g., as described above in relation to FIGS. 10A-10B). Selectively causing the external light to illuminate light with a respective characteristic when a set of prescribed conditions is met automatically allows the computer system to tailor the illumination of the physical space to the preferences of the user, thereby performing an operation when a set of conditions has been met without requiring further user input.

In some embodiments, while detecting, via the input device, that the physical environment (e.g., 600) includes the respective color of light, the computer system provides, via the external light source (e.g., 612a-612d), illumination in a sixth manner (e.g., a location, a color, an intensity, and/or a size of illumination) (e.g., as described above in relation to FIGS. 10A-10B). In some embodiments, the sixth manner is the same or different from the first manner and/or the second manner. In some embodiments, detecting that the physical environment includes the respective color of light causes the computer system to provide, via the external light source, illumination in the sixth manner. In some embodiments, the computer system ceases, to provide illumination in the sixth manner, via the external light source, when it is no longer detected that the physical environment includes the respective color of light. Providing illumination in the sixth manner while detecting that the physical environment includes the respective color of light allows the computer system to provide illumination to a physical space such that the physical space is not solely illuminated via the respective color of light, thereby performing an operation (e.g., providing illumination) when a set of conditions (while the computer system detects that the physical environment includes the respective color of light) has been met without requiring further user input.

In some embodiments, the respective color of light included in the physical environment is detected without detecting input (e.g., input from a user and/or subject). In some embodiments, the respective color of light is detected while the physical environment (e.g., 600) is not illuminated (e.g., not currently and/or not presently) via the external light source (e.g., 612a-612d) (e.g., as described above in relation to FIGS. 10A-10B). In some embodiments, the physical environment is illuminated via a respective light source while the color of light included in the physical environment is detected. In some embodiments, the physical environment is not illuminated via any respective light source while the color included in the physical environment is detected. In some embodiments, the respective color of light included in the physical environment is detected in response to detecting an input. Detecting the respective color of light without detecting an input allows the computer system to (e.g., without intervening user input) continually provide illumination in a respective manner based on changes to the respective color of light of the physical environment without being prompted by the user, thereby providing additional control options without cluttering the user interface with additional displayed controls.

In some embodiments, providing illumination in the first manner includes outputting, via the external light source (e.g., 612a-612d), a sixth color (e.g., red, orange, green, yellow, and/or purple). In some embodiments, detecting that the physical environment (e.g., 600) includes the respective color of light includes detecting, via the input device, an input (e.g., tap input, swipe input, air input, depression of a hardware button, voice command, and/or gaze) that corresponds to a request to illuminate the physical environment with a seventh color different from the sixth color (e.g., as described above in relation to FIGS. 10A-10B). In some embodiments, the input corresponds to a request to illuminate the physical environment using a color that is different from the color that corresponds to the second manner. In some embodiments, the input that corresponds to the request to illuminate the physical environment with the seventh color includes a selection of a user interface object that is displayed via a display of the computer system. In some embodiments, providing illumination in the second manner includes outputting, via the external light source, the seventh color.

In some embodiments, providing illumination in the first manner includes outputting, via the external light source (e.g., 612a-612d), an eighth color (e.g., red, orange, green, yellow, and/or purple). In some embodiments, detecting that the physical environment (e.g., 600) includes the respective color of light includes detecting, via the input device, an input (e.g., tap input, swipe input, air input, depression of a hardware button, voice command, and/or gaze) that corresponds to a request to illuminate the physical environment with the eighth color (e.g., as described above in relation to FIGS. 10A-10B). Outputting the eighth color in response to detecting an input that corresponds to a request to illuminate the physical environment with the eighth color allows the computer system to provide illumination to the physical environment based on the explicit preferences of the user, thereby providing improved feedback.

In some embodiments, the computer system is in communication (e.g., wireless communication and/or wired communication) with a set of one or more cameras. In some embodiments, detecting that the physical environment includes the respective color of light includes capturing, via the set of one or more cameras (e.g., 612a-612d), an image (e.g., a still image and/or a video) of the physical environment (e.g., an image that includes the respective color) (e.g., as described above in relation to FIGS. 10A-10B). In some embodiments, detecting that the physical environment includes the respective color of light is done via the image of the physical environment. In some embodiments, the image of the physical environment is captured before the respective light of the physical environment is detected. In some embodiments, the set of one or more cameras captures the image of the physical environment in response to detecting a request to determine the respective color of light within the physical environment. In some embodiments, capturing the image of the physical environment is done automatically (e.g., without user intervention and/or intervening input).

Note that details of the processes described above with respect to method 1100 (e.g., FIG. 11) are also applicable in an analogous manner to the methods described herein. For example, method 700 optionally includes one or more of the characteristics of the various methods described herein. For example, a physical space can be illuminated using one or more techniques described herein in relation to method 700, where the illumination of the physical space is initiated using one or more techniques described in relation to method 700 and the illumination is based on the detection of a respective color of light within the physical space as described in relation to method 1100. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the illumination a physical space. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for illuminating a physical space. Accordingly, use of such personal information data enables users to have a computer system perform operations for illuminating a physical space. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to some services, or publicly available information.

What is claimed is:

1. A method, comprising:
at a computer system that is in communication with an external light source and an input device:
detecting, via the input device, that a physical environment includes a respective color of light; and
in response to detecting that the physical environment includes the respective color of light:
in accordance with a determination that the respective color is a first color, providing, via the external light source, illumination in a first manner; and
in accordance with a determination that the respective color is a second color different from the first color, providing, via the external light source, illumination in a second manner different from the first manner.

2. The method of claim 1, wherein providing illumination in the first manner includes increasing, via the external light source, a first amount of illumination within the physical environment.

3. The method of claim 1, wherein providing illumination in the first manner includes decreasing, via the external light source, a second amount of illumination within the physical environment.

4. The method of claim 1, wherein providing illumination in the first manner includes outputting, via the external light source, a third color, and wherein providing illumination in the second manner includes outputting, via the external light source, a fourth color different from the third color.

5. The method of claim 1, wherein providing illumination in the first manner includes outputting, via the external light source, a color that neutralizes the respective color.

6. The method of claim 1, further comprising:
while detecting that the physical environment includes the respective color of light, providing, via the external light source, illumination in a third manner; and
in response to detecting that the physical environment includes the respective color of light and in accordance with a determination that the respective color is a fifth color different from the first color and the second color, continuing to provide, via the external light source, illumination in the third manner.

7. The method of claim 1, wherein the respective color of light is a first respective color of light, the method further comprising:
while providing, via the external light source, illumination in the first manner, detecting, via the input device, that the respective color of light changes from the first respective color of light to a second respective color of light; and
in response to detecting that the respective color of light changes from the first respective color of light to the second respective color of light, providing, via the external light source, illumination in a fourth manner different from the first manner.

8. The method of claim 1, wherein providing, via the external light source, illumination in the first manner includes outputting a color of light that is different than the respective color of light.

9. The method of claim 1, wherein the external light source includes a first external light and a second external light different from the first external light, and wherein providing, via the light source, illumination in the first manner includes:
causing the first external light to provide first illumination; and
causing the second external light to provide second illumination.

10. The method of claim 1, wherein providing, via the external light source, illumination in the first manner includes:
during a first period of time while providing the illumination in the first manner, changing, via the light source, the illumination by a first illumination amount; and
during a second period of time, different from the first period of time, while providing the illumination in the first manner, changing, via the light source, the illumination by a second illumination amount different from the first illumination amount.

11. The method of claim 1, wherein providing, via the external light source, illumination in the first manner includes:
in accordance with a determination that a detected user preference is a first user preference, causing the external light source to illuminate light with a first characteristic and not a second characteristic; and
in accordance with a determination that the detected user preference is a second user preference different from the first user preference, causing the external lights source to illuminate light with the second characteristic and not the first characteristic.

12. The method of claim 1, further comprising:
while detecting, via the input device, that the physical environment includes the respective color of light, providing, via the external light source, illumination in a sixth manner.

13. The method of claim 1, wherein the respective color of light included in the physical environment is detected without detecting input, and wherein the respective color of light is detected while the physical environment is not illuminated via the external light source.

14. The method of claim 1, wherein providing illumination in the first manner includes outputting, via the external light source, a sixth color, and wherein detecting that the physical environment includes the respective color of light includes detecting, via the input device, an input that corresponds to a request to illuminate the physical environment with a seventh color different from the sixth color.

15. The method of claim 1, wherein providing illumination in the first manner includes outputting, via the external light source, an eighth color, and wherein detecting that the physical environment includes the respective color of light includes detecting, via the input device, an input that corresponds to a request to illuminate the physical environment with the eighth color.

16. The method of claim 1, wherein the computer system is in communication with a set of one or more cameras, and wherein detecting that the physical environment includes the respective color of light includes capturing, via the set of one or more cameras, an image of the physical environment.

17. A non-transitory computer-readable storage medium storing one or more programs configured to be executed by one or more processors of a computer system that is in communication with an external light source and an input device, the one or more programs including instructions for:
detecting, via the input device, that a physical environment includes a respective color of light; and
in response to detecting that the physical environment includes the respective color of light:
in accordance with a determination that the respective color is a first color, providing, via the external light source, illumination in a first manner; and
in accordance with a determination that the respective color is a second color different from the first color, providing, via the external light source, illumination in a second manner different from the first manner.

18. A computer system configured to communicate with an external light source and an input device, comprising:
one or more processors; and
memory storing one or more programs configured to be executed by the one or more processors, the one or more programs including instructions for:
detecting, via the input device, that a physical environment includes a respective color of light; and
in response to detecting that the physical environment includes the respective color of light:
in accordance with a determination that the respective color is a first color, providing, via the external light source, illumination in a first manner; and
in accordance with a determination that the respective color is a second color different from the first color, providing, via the external light source, illumination in a second manner different from the first manner.
